(19) United States
(12) Patent Application Publication
(10) Pub. No.: US 2022/0104280 A1
(43) Pub. Date: Mar. 31, 2022

(54) METHOD FOR TRANSMITTING AND RECEIVING SIGNAL IN WIRELESS COMMUNICATION SYSTEM AND APPARATUS FOR SUPPORTING SAME

(71) Applicant: LG Electronics Inc., Seoul (KR)

(72) Inventors: Suckchel YANG, Seoul (KR); Joonkui AHN, Seoul (KR); Seonwook KIM, Seoul (KR)

(21) Appl. No.: 17/440,066

(22) PCT Filed: Mar. 30, 2020
(86) PCT No.: PCT/KR2020/095053

§ 371 Date: Sep. 16, 2021

(30) Foreign Application Priority Data
Mar. 29, 2019 (KR) 10-2019-0036820
Jul. 31, 2019 (KR) 10-2019-0093515

(51) Int. Cl. H04W 74/08; H04W 56/00; H04W 72/04

(52) U.S. Cl. CPC H04W 74/0841; H04W 74/0866; H04W 72/0453; H04W 56/0045

(57) ABSTRACT

The present disclosure relates to a wireless communication system. Particularly, a method and a device therefor are provided, the method comprising the steps of: transmitting a physical random access channel (PRACH) on the basis of a channel sensing result; receiving a random access response (RAR) as a response to the PRACH; and transmitting a physical uplink shared channel (PUSCH) on the basis of the RAR, wherein the PUSCH is transmitted on a first resource which has succeeded in channel sensing from among a plurality of candidate resources, and the plurality of candidate resources include a plurality of symbol groups or a plurality of frequency domains.

### TECHNICAL FIELD

The present disclosure relates to a method of transmitting and receiving signals in a wireless communication system supportive of an unlicensed band and apparatus for supporting the same.

### BACKGROUND

Wireless access systems have been widely deployed to provide various types of communication services such as voice or data. In general, a wireless access system is a multiple access system that supports communication of multiple users by sharing available system resources (a bandwidth, transmission power, etc.) among them. For example, multiple access systems include a code division multiple access (CDMA) system, a frequency division multiple access (FDMA) system, a time division multiple access (TDMA) system, an orthogonal frequency division multiple access (OFDMA) system, and a single carrier frequency division multiple access (SC-FDMA) system.

### SUMMARY

One technical task of the present disclosure is to provide a method of efficiently performing a wireless signal transceiving process and apparatus therefor.

It will be appreciated by persons skilled in the art that the objects that could be achieved with the present disclosure are not limited to what has been particularly described hereinabove and the above and other objects that the present disclosure could achieve will be more clearly understood from the following detailed description.

In one technical aspect of the present disclosure, provided is a method by a user equipment in a wireless communication system, the method including transmitting a Physical Random Access Channel (PRACH) based on a channel sensing result, receiving a Random Access Response (RAR) in response to the PRACH, and transmitting a Physical Uplink Shared Channel (PUSCH) based on the RAR, wherein the PUSCH may be transmitted on a first resource succeeding in channel sensing among multiple candidate resources and wherein the multiple candidate resources may include multiple symbol groups or multiple frequency regions.

In another technical aspect of the present disclosure, provided is a user equipment in a wireless communication system, the user equipment including at least one processor, at least one transceiver, and at least one computer memory operationally connected to the at least one processor and the at least one transceiver and enabling the at least one processor and the at least one transceiver to perform an operation when executed, wherein the operation may include transmitting a Physical Random Access Channel (PRACH) based on a channel sensing result, receiving a Random Access Response (RAR) in response to the PRACH, and transmitting a Physical Uplink Shared Channel (PUSCH) based on the RAR, wherein the PUSCH may be transmitted on a first resource succeeding in channel sensing among multiple candidate resources, and wherein the multiple candidate resources may include multiple symbol groups or multiple frequency regions.

In further technical aspect of the present disclosure, provided is an apparatus for a user equipment, the apparatus including at least one processor and at least one memory storing one or more commands enabling the at least one processor to perform an operation, wherein the operation may include transmitting a Physical Random Access Channel (PRACH) based on a channel sensing result, receiving a Random Access Response (RAR) in response to the PRACH, and transmitting a Physical Uplink Shared Channel (PUSCH) based on the RAR, wherein the PUSCH may be transmitted on a first resource succeeding in channel sensing among multiple candidate resources, and wherein the multiple candidate resources may include multiple symbol groups or multiple frequency regions.

In another further technical aspect of the present disclosure, provided is a processor-readable medium storing one or more commands enabling at least one processor to perform an operation, wherein the operation may include transmitting a Physical Random Access Channel (PRACH) based on a channel sensing result, receiving a Random Access Response (RAR) in response to the PRACH, and transmitting a Physical Uplink Shared Channel (PUSCH) based on the RAR, wherein the PUSCH may be transmitted on a first resource succeeding in channel sensing among multiple candidate resources, and wherein the multiple candidate resources may include multiple symbol groups or multiple frequency regions

Preferably, allocation information of the multiple candidate resources may be included in System Information Block (SIB) or the RAR.

Preferably, the method may include receiving a Physical Downlink Shared Channel (PDSCH) including Radio Access Control (RRC) connection information in response to the PUSCH, and the PDSCH may be received on one of: i) a carrier pre-configured via a higher layer signal; ii) a carrier indicated via a Physical Downlink Control Channel (PDCCH) including scheduling information of the PDSCH; or iii) a carrier indicated via the RAR.

Preferably, the PDSCH may include a Timing Advance (TA) command and response information to the reception of the PDSCH may be transmitted on a Physical Uplink Control Channel (PUCCH) having TA applied thereto based on the TA command.

Preferably, the method may include receiving index information of a resource from which the PUSCH is detected, and the index information may be included in the PDSCH or the scheduling information.

Preferably, the multiple candidate resources may be identified with different Temporary Cell-Radio Network Temporary Identifiers (TC-RNTIs) and the PDCCH may be indicated by the TC-RNTI related to the first resource.

Devises applied to embodiments of the present disclosure may include an autonomous driving device.

The aspects of the present disclosure described above are only some of the preferred embodiments of the present disclosure, and a variety of embodiments reflecting the technical features of the present disclosure can be derived and understood by those skilled in the art, to which the present disclosure pertains, based on the detailed description of the present disclosure described below.

According to embodiments of the present disclosure, signal transmission and reception may be performed efficiently in a wireless communication system.

According to embodiments of the present disclosure, a random access process on an unlicensed band may be performed efficiently.

According to embodiments of the present disclosure, an access delay due to channel sensing on an unlicensed band may be reduced.

The effects that may be achieved with embodiments of the present disclosure are not limited to what has been particularly described hereinabove and other advantages not described herein will be more clearly understood by persons skilled in the art from the following detailed description of the present disclosure. That is, unintended effects in implementing the present disclosure may also be derived by those skilled in the art from the embodiments of the present disclosure.

### BRIEF DESCRIPTION OF THE DRAWINGS

The accompanying drawings, which are included to provide a further understanding of the disclosure, illustrate embodiments of the present disclosure and together with the description serve to explain the principle of the present disclosure.

FIG. 1 illustrates physical channels and a general signal transmission method using the physical channels in a 3^{rd} generation partnership project (3GPP) system as an exemplary wireless communication system.

FIG. 2 shows an example of a network initial access and a communication process thereafter.

FIG. 3 shows an example of a DRX (Discontinuous Reception) cycle.

FIG. 4 illustrates a radio frame structure.

FIG. 5 illustrates a resource grid during the duration of a slot.

FIG. 6 illustrates a self-contained slot structure.

FIG. 7 illustrates mapping of physical channels in a self-contained slot.

FIG. 8 illustrates a wireless communication system supporting an unlicensed band.

FIG. 9 illustrates an exemplary method of occupying resources in an unlicensed band.

FIG. 10 illustrates an exemplary channel access procedure of a UE for DL signal transmission in an unlicensed band applicable to the present disclosure.

FIG. 11 illustrates an exemplary channel access procedure of a UE for UL signal transmission in an unlicensed band applicable to the present disclosure.

FIG. 12 shows an example of a general random access process.

FIG. 13 and FIG. 14 show a signal transmitting process according to an embodiment of the present disclosure.

FIG. 15 shows an example related to a Scheduling Request (SR) transmitting operation.

FIG. 16 illustrates an exemplary communication system applied to the present disclosure.

FIG. 17 illustrates an exemplary wireless device applicable to the present disclosure.

FIG. 18 illustrates another exemplary wireless device applicable to the present disclosure.

FIG. 19 illustrates an exemplary vehicle or autonomous driving vehicle applicable to the present disclosure.

### DETAILED DESCRIPTION

The following technology may be used in various wireless access systems such as code division multiple access (CDMA), frequency division multiple access (FDMA), time division multiple access (TDMA), orthogonal frequency division multiple access (OFDMA), single carrier frequency division multiple access (SC-FDMA), and so on. CDMA may be implemented as a radio technology such as universal terrestrial radio access (UTRA) or CDMA2000. TDMA may be implemented as a radio technology such as global system for mobile communications (GSM)/general packet radio service (GPRS)/enhanced data rates for GSM evolution (EDGE). OFDMA may be implemented as a radio technology such as institute of electrical and electronics engineers (IEEE) 802.11 (wireless fidelity (Wi-Fi)), IEEE 802.16 (worldwide interoperability for microwave access (WiMAX)), IEEE 802.20, evolved UTRA (E-UTRA), and so on. UTRA is a part of universal mobile telecommunications system (UMTS). 3^{rd} generation partnership project (3GPP) long term evolution (LTE) is a part of evolved UMTS (E-UMTS) using E-UTRA, and LTE-advanced (LTE-A) is an evolution of 3GPP LTE. 3GPP new radio or new radio access technology (NR) is an evolved version of 3GPP LTE/LTE-A.

As more and more communication devices require larger communication capacities, the need for enhanced mobile broadband communication relative to the legacy radio access technologies (RATs) has emerged. Massive machine type communication (MTC) providing various services to inter-connected multiple devices and things at any time in any place is one of significant issues to be addressed for next-generation communication. A communication system design in which services sensitive to reliability and latency are considered is under discussion as well. As such, the introduction of the next-generation radio access technology (RAT) for enhanced mobile broadband communication (eMBB), massive MTC (mMTC), and ultra-reliable and low latency communication (URLLC) is being discussed. For convenience, this technology is called NR or New RAT in the present disclosure.

To clarify the explanation, 3GPP NR is mainly described, by which the technical ideas of the present disclosure are non-limited.

The General of 3GPP System

In a wireless access system, a user equipment (UE) receives information from a base station (BS) on DL and transmits information to the BS on UL. The information transmitted and received between the UE and the BS includes general data and various types of control information. There are many physical channels according to the types/usages of information transmitted and received between the BS and the UE.

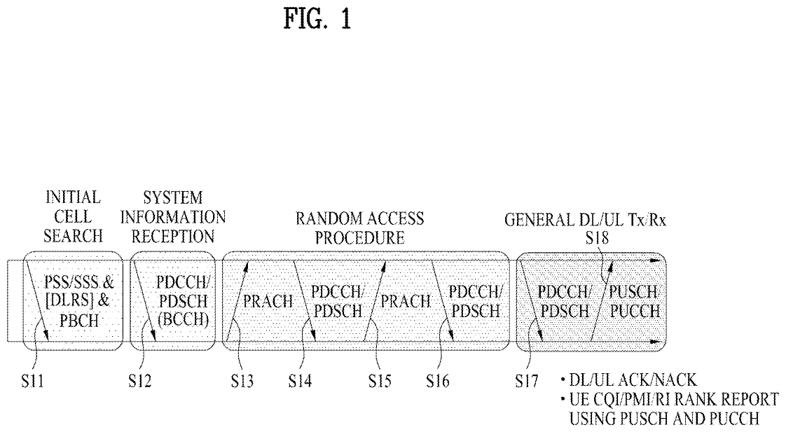

FIG. 1 illustrates physical channels and a general signal transmission method using the physical channels in a 3GPP system.

When a UE is powered on or enters a new cell, the UE performs initial cell search (S11). The initial cell search involves acquisition of synchronization to a BS. For this purpose, the UE receives a synchronization signal block (SSB) from the BS. The SSB includes a primary synchronization signal (PSS), a secondary synchronization signal (SSS), and a physical broadcast channel (PBCH). The UE synchronizes its timing to the BS and acquires information such as a cell identifier (ID) based on the PSS/SSS. Further, the UE may acquire information broadcast in the cell by receiving the PBCH from the BS. During the initial cell search, the UE may also monitor a DL channel state by receiving a downlink reference signal (DL RS).

After the initial cell search, the UE may acquire more detailed system information by receiving a physical downlink control channel (PDCCH) and a physical downlink shared channel (PDSCH) corresponding to the PDCCH (S12).

Subsequently, to complete connection to the BS, the UE may perform a random access procedure with the BS (S13 to S16). Specifically, the UE may transmit a preamble on a physical random access channel (PRACH) (S13) and may receive a PDCCH and a random access response (RAR) for the preamble on a PDSCH corresponding to the PDCCH (S14). The UE may then transmit a physical uplink shared channel (PUSCH) by using scheduling information in the RAR (S15), and perform a contention resolution procedure including reception of a PDCCH and a PDSCH signal corresponding to the PDCCH (S16).

When the random access procedure is performed in two steps, steps S13 and S15 may be performed as one step (in which Message A is transmitted by the UE), and steps S14 and S16 may be performed as one step (in which Message B is transmitted by the BS).

After the above procedure, the UE may receive a PDCCH and/or a PDSCH from the BS (S17) and transmit a physical uplink shared channel (PUSCH) and/or a physical uplink control channel (PUCCH) to the BS (S18), in a general UL/DL signal transmission procedure. Control information that the UE transmits to the BS is generically called uplink control information (UCI). The UCI includes a hybrid automatic repeat and request acknowledgement/negative acknowledgement (HARQ-ACK/NACK), a scheduling request (SR), channel state information (CSI), and so on. The CSI includes a channel quality indicator (CQI), a precoding matrix index (PMI), a rank indication (RI), and so on. In general, UCI is transmitted on a PUCCH. However, if control information and data should be transmitted simultaneously, the control information and the data may be transmitted on a PUSCH. In addition, the UE may transmit the UCI aperiodically on the PUSCH, upon receipt of a request/command from a network.

A User Equipment (UE) may perform a network access procedure to implement the described/proposed procedures and/or methods of the present disclosure. For example, while performing an access to a network (e.g., a Base Station (BS)), a UE can receive and store system information and configuration information necessary to perform the described/proposed procedures and/or methods described later in memory. Configuration informations necessary for the present disclosure may be received through signaling of higher layers (e.g., RRC layer, Medium Access Control (MAC) layer, etc.).

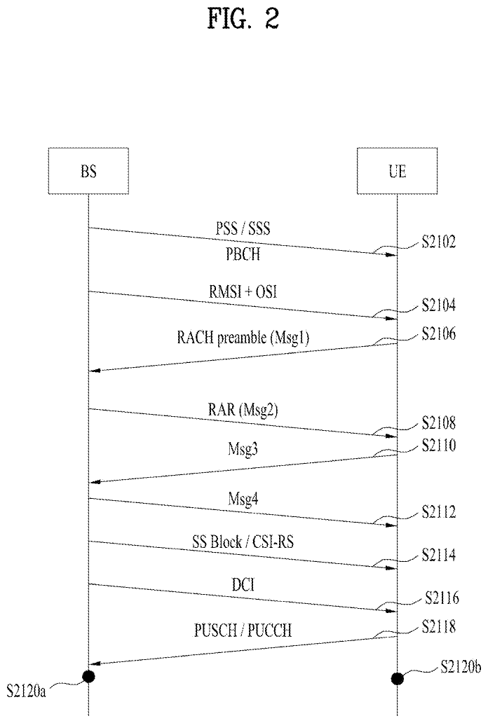

FIG. 2 is a diagram illustrating an initial network access and subsequent communication process. In an NR system to which various embodiments of the present disclosure are applicable, a physical channel and an RS may be transmitted by beamforming. When beamforming-based signal transmission is supported, beam management may be performed for beam alignment between a BS and a UE. Further, a signal proposed in various embodiments of the present disclosure may be transmitted/received by beamforming. In RRC_IDLE mode, beam alignment may be performed based on a synchronization signal block (SSB or SS/PBCH block), whereas in RRC_CONNECTED mode, beam alignment may be performed based on a CSI-RS (in DL) and an SRS (in UL). On the contrary, when beamforming-based signal transmission is not supported, beam-related operations may be omitted in the following description.

Referring to FIG. 2, a Base Station (e.g., BS) may periodically transmit an SSB (S2702). The SSB includes a PSS/SSS/PBCH. The SSB may be transmitted by beam sweeping. The BS may then transmit remaining minimum system information (RMSI) and other system information (OSI) (S2704). The RMSI may include information required for the UE to perform initial access to the BS (e.g., PRACH configuration information). After detecting SSBs, the UE identifies the best SSB. The UE may then transmit an RACH preamble (Message 1; Msg1) in PRACH resources linked/corresponding to the index (i.e., beam) of the best SSB (S2706). The beam direction of the RACH preamble is associated with the PRACH resources. Association between PRACH resources (and/or RACH preambles) and SSBs (SSB indexes) may be configured by system information (e.g., RMSI). Subsequently, in an RACH procedure, the BS may transmit a random access response (RAR) (Msg2) in response to the RACH preamble (S2708), the UE may transmit Msg3 (e.g., RRC Connection Request) based on a UL grant included in the RAR (S2710), and the BS may transmit a contention resolution message (Msg4) (S2712). Msg4 may include RRC Connection Setup.

When an RRC connection is established between the BS and the UE in the RACH procedure, beam alignment may subsequently be performed based on an SSB/CSI-RS (in DL) and an SRS (in UL). For example, the UE may receive an SSB/CSI-RS (S2714). The SSB/CSI-RS may be used for the UE to generate a beam/CSI report. The BS may request the UE to transmit a beam/CSI report, by DCI (S2716). In this case, the UE may generate a beam/CSI report based on the SSB/CSI-RS and transmit the generated beam/CSI report to the BS on a PUSCH/PUCCH (S2718). The beam/CSI report may include a beam measurement result, information about a preferred beam, and so on. The BS and the UE may switch beams based on the beam/CSI report (52720a and 52720b).

Subsequently, the UE and the BS may perform the above-described/proposed procedures and/or methods. For example, the UE and the BS may transmit a wireless signal by processing information stored in a memory or may process received wireless signal and store the processed signal in the memory according to various embodiments of the present disclosure, based on configuration information obtained in the network access process (e.g., the system information acquisition process, the RRC connection process through an RACH, and so on). The wireless signal may include at least one of a PDCCH, a PDSCH, or an RS on DL and at least one of a PUCCH, a PUSCH, or an SRS on UL.

A UE may perform a Discontinuous Reception (DRX) operation while performing embodiments of the present disclosure described later. A DRC configured UE may reduce power consumption by discontinuously receiving a DL signal. DRX may be performed in Radio

Resource Control_IDLE mode (i.e., RRC_IDLE mode), RRC_INACTIVE mode, or RRC_CONNECTED mode. In RRC_IDLE mode and RRC_INACTIVE mode, DRX is used to receive a paging signal discontinuously. Hereinafter, DRX performed in RRC_CONNECTED mode is described (RRC_CONNECTED DRX).

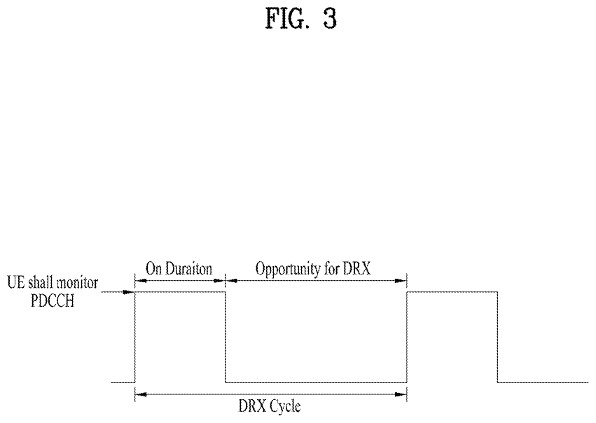

FIG. 3 illustrates a DRX cycle (RRC_CONNECTED mode).

Referring to FIG. 3, a DRX cycle includes an On Duration and an Opportunity for DRX. The DRX cycle defines a time interval between periodic repetitions of the On Duration. The On Duration is a time period during which the UE monitors a PDCCH. When the UE is configured with DRX, the UE performs PDCCH monitoring during the On Duration. When the UE successfully detects a PDCCH during the PDCCH monitoring, the UE starts an inactivity timer and is kept awake. On the contrary, when the UE fails in detecting any PDCCH during the PDCCH monitoring, the UE transitions to a sleep state after the On Duration. Accordingly, when DRX is configured, the UE may perform PDCCH monitoring/reception discontinuously in the time domain in the afore-described procedures and/or methods. For example, when DRX is configured, PDCCH reception occasions (e.g., slots with PDCCH search spaces) may be configured discontinuously according to a DRX configuration in the present disclosure. On the contrary, when DRX is not configured, the UE may perform PDCCH monitoring/reception continuously in the time domain in the afore-described procedures and/or methods according to implementation(s). For example, when DRX is not configured, PDCCH reception occasions (e.g., slots with PDCCH search spaces) may be configured continuously in the present disclosure. Irrespective of whether DRX is configured, PDCCH monitoring may be restricted during a time period configured as a measurement gap.

Table 1 describes a DRX operation of a UE (in the RRC_CONNECTED state). Referring to Table 1, DRX configuration information is received by higher-layer signaling (e.g., RRC signaling), and DRX ON/OFF is controlled by a DRX command from the MAC layer. Once DRX is configured, the UE may perform PDCCH monitoring discontinuously the afore-described procedures and/or methods according to various embodiments of the present disclosure.

TABLE 1

| | Type of signals | UE procedure |
|---|---|---|
| 1^{st} step | RRC signalling | Receive DRX configuration |
| | (MAC-CellGroupConfig) | information |
| 2^{nd} Step | MAC CE ((Long) DRX | Receive DRX command |
| | command MAC CE) | |
| 3^{rd} Step | — | Monitor a PDCCH during an |
| | | on-duration of a DRX cycle |

MAC-CellGroupConfig includes configuration information required to configure MAC parameters for a cell group. MAC-CellGroupConfig may also include DRX configuration information. For example, MAC-CellGroupConfig may include the following information in defining DRX.
Value of drx-OnDurationTimer: defines the duration of the starting period of the DRX cycle.
Value of drx-InactivityTimer: defines the duration of a time period during which the UE is awake after a PDCCH occasion in which a PDCCH indicating initial UL or DL data has been detected.
Value of drx-HARQ-RTT-TimerDL: defines the duration of a maximum time period until a DL retransmission is received after reception of a DL initial transmission.
Value of drx-HARQ-RTT-TimerDL: defines the duration of a maximum time period until a grant for a UL retransmission is received after reception of a grant for a UL initial transmission.
drx-LongCycleStartOffset: defines the duration and starting time of a DRX cycle.
drx-ShortCycle (optional): defines the duration of a short DRX cycle.

When any of drx-OnDurationTimer, drx-InactivityTimer, drx-HARQ-RTT-TimerDL, and drx-HARQ-RTT-TimerDL is running, the UE performs PDCCH monitoring in each PDCCH occasion, staying in the awake state.

For example, according to an embodiment of the present disclosure, if DRX is configured in a UE of the present disclosure, a DL signal may be received in a DRX-on duration.

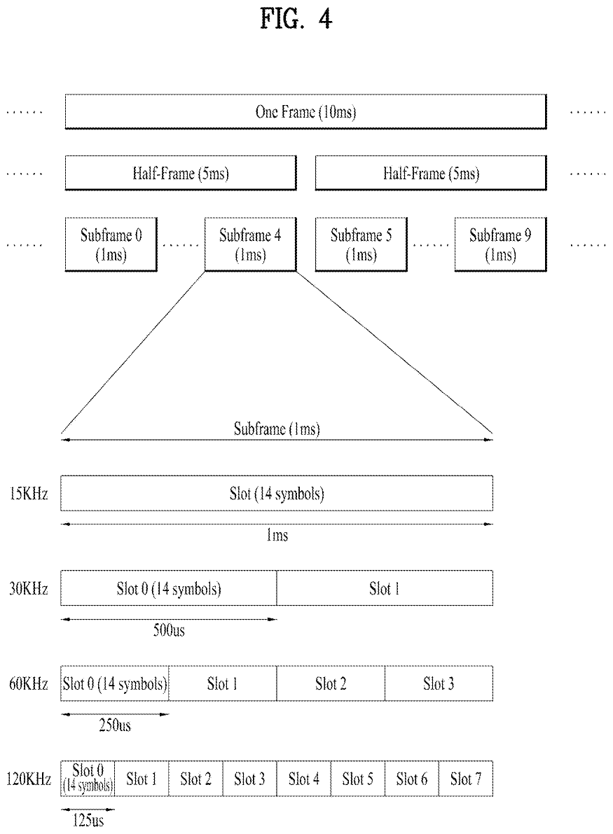

FIG. 4 illustrates a radio frame structure.

In NR, UL and DL transmissions are configured in frames. Each radio frame has a length of 10 ms and is divided into two 5-ms half-frames. Each half-frame is divided into five 1-ms subframes. A subframe is divided into one or more slots, and the number of slots in a subframe depends on a subcarrier spacing (SCS). Each slot includes 12 or 14 OFDM(A) symbols according to a cyclic prefix (CP). When a normal CP is used, each slot includes 14 OFDM symbols. When an extended CP is used, each slot includes 12 OFDM symbols. A symbol may include an OFDM symbol (or a CP-OFDM symbol) and an SC-FDMA symbol (or a discrete Fourier transform-spread-OFDM (DFT-s-OFDM) symbol).

Table 2 exemplarily illustrates that the number of symbols per slot, the number of slots per frame, and the number of slots per subframe vary according to SCSs in a normal CP case.

TABLE 2

| | | | |
|---|---|---|---|
| SCS (15*2\hat{ }u) | N^{slot}_{symb} | N^{frame, u}ₛₗₒₜ | N^{subframe, u}ₛₗₒₜ |

| | | | | |
|---|---|---|---|---|
| 15 KHz | (u = 0) | 14 | 10 | 1 |
| 30 KHz | (u = 1) | 14 | 20 | 2 |
| 60 KHz | (u = 2) | 14 | 40 | 4 |
| 120 KHz | (u = 3) | 14 | 80 | 8 |
| 240 KHz | (u = 4) | 14 | 160 | 16 |

* N^{slot}_{symb}: number of symbols in a slot
* N^{frame, u}ₛₗₒₜ: number of slots in a frame
* N^{subframe, u}ₛₗₒₜ: number of slots in a subframe

Table 3 illustrates that the number of symbols per slot, the number of slots per frame, and the number of slots per subframe vary according to SCSs in an extended CP case.

TABLE 3

| SCS (15*2\hat{ }u) | N^{slot}_{symb} | N^{frame, u}ₛₗₒₜ | N^{subframe, u}ₛₗₒₜ |
|---|---|---|---|
| 60 KHz (u = 2) | 12 | 40 | 4 |

The frame structure is merely an example, and the number of subframes, the number of slots, and the number of symbols in a frame may be changed in various manners.

In the NR system, different OFDM(A) numerologies (e.g., SCSs, CP lengths, and so on) may be configured for a plurality of cells aggregated for one UE. Accordingly, the (absolute time) duration of a time resource (e.g., a subframe, a slot, or a transmission time interval (TTI)) (for convenience, referred to as a time unit (TU)) composed of the same number of symbols may be configured differently between the aggregated cells.

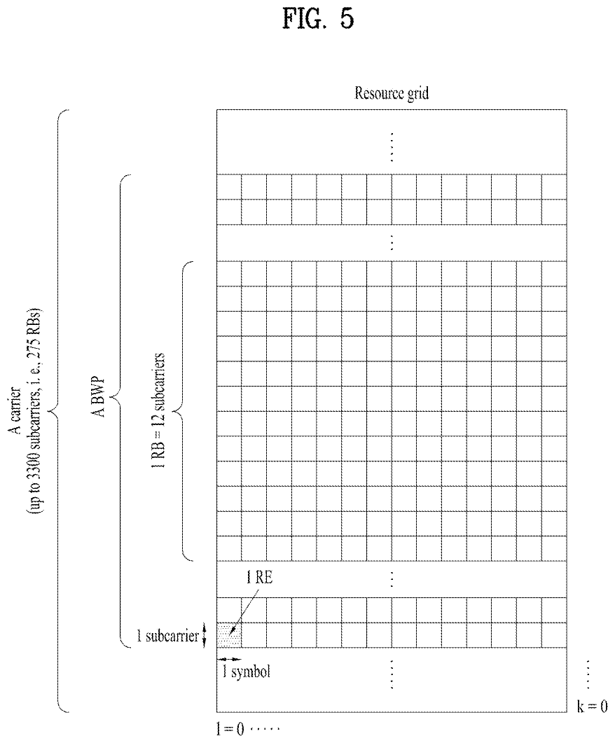

FIG. 5 illustrates a resource grid during the duration of one slot.

A slot includes a plurality of symbols in the time domain. For example, one slot includes 14 symbols in a normal CP case and 12 symbols in an extended CP case. A carrier includes a plurality of subcarriers in the frequency domain. A resource block (RB) may be defined by a plurality of (e.g., 12) consecutive subcarriers in the frequency domain. A bandwidth part (BWP) may be defined by a plurality of consecutive (physical) RBs ((P)RBs) in the frequency domain and correspond to one numerology (e.g., SCS, CP length, and so on). A carrier may include up to N (e.g., 5) BWPs. Data communication may be conducted in an active BWP, and only one BWP may be activated for one UE. Each element in a resource grid may be referred to as a resource element (RE), to which one complex symbol may be mapped.

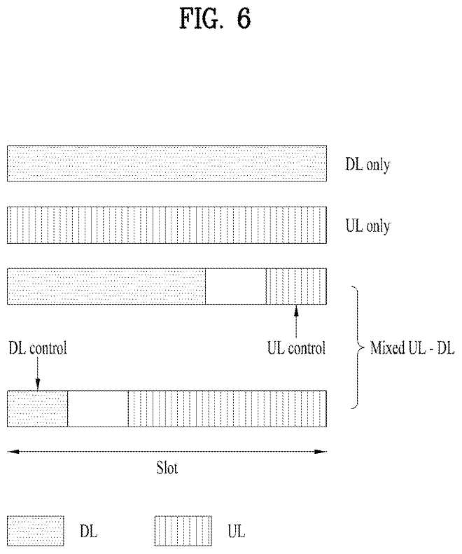

FIG. 6 illustrates a structure of a self-contained slot.

In the NR system, a frame has a self-contained structure in which a DL control channel, DL or UL data, a UL control channel, and the like may all be contained in one slot. For example, the first N symbols (hereinafter, DL control region) in the slot may be used to transmit a DL control channel, and the last M symbols (hereinafter, UL control region) in the slot may be used to transmit a UL control channel. N and M are integers greater than or equal to 0. A resource region (hereinafter, a data region) that is between the DL control region and the UL control region may be used for DL data transmission or UL data transmission. For example, the following configuration may be considered. Respective sections are listed in a temporal order.

1. DL only configuration

2. UL only configuration

3. Mixed UL-DL configuration
DL region+Guard period (GP)+UL control region
DL control region+GP+UL region
DL region: (i) DL data region, (ii) DL control region+DL data region
UL region: (i) UL data region, (ii) UL data region+UL control region

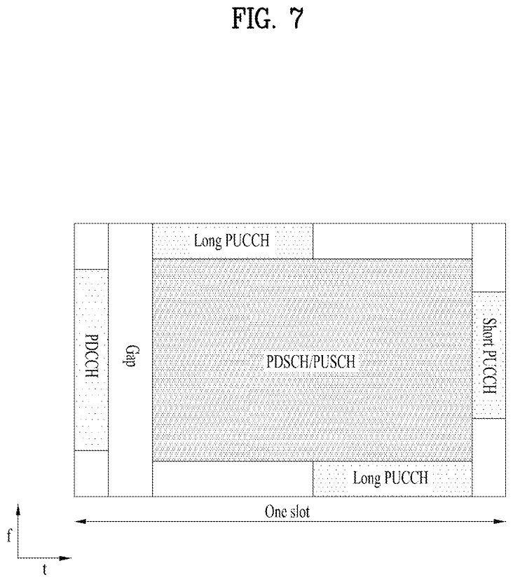

FIG. 7 illustrates mapping of physical channels in a self-contained slot. The PDCCH may be transmitted in the DL control region, and the PDSCH may be transmitted in the DL data region. The PUCCH may be transmitted in the UL control region, and the PUSCH may be transmitted in the UL data region. The GP provides a time gap in the process of the UE switching from the transmission mode to the reception mode or from the reception mode to the transmission mode. Some symbols at the time of switching from DL to UL within a subframe may be configured as the GP.

Now, a detailed description will be given of physical channels.

The PDCCH delivers DCI. For example, the PDCCH (i.e., DCI) may carry information about a transport format and resource allocation of a DL shared channel (DL-SCH), resource allocation information of an uplink shared channel (UL-SCH), paging information on a paging channel (PCH), system information on the DL-SCH, information on resource allocation of a higher-layer control message such as an RAR transmitted on a PDSCH, a transmit power control command, information about activation/release of configured scheduling, and so on. The DCI includes a cyclic redundancy check (CRC). The CRC is masked with various identifiers (IDs) (e.g. a radio network temporary identifier (RNTI)) according to an owner or usage of the PDCCH. For example, if the PDCCH is for a specific UE, the CRC is masked by a UE ID (e.g., cell-RNTI (C-RNTI)). If the PDCCH is for a paging message, the CRC is masked by a paging-RNTI (P-RNTI). If the PDCCH is for system information (e.g., a system information block (SIB)), the CRC is masked by a system information RNTI (SI-RNTI). When the PDCCH is for an RAR, the CRC is masked by a random access-RNTI (RA-RNTI).

The PDCCH may include 1, 2, 4, 8, or 16 control channel elements (CCEs) depending on the aggregation level (AL). The CCE is a logical allocation unit for providing the PDCCH with a predetermined coding rate based on the state of a radio channel. The PDCCH is transmitted in a control resource set (CORESET). The CORESET is defined as a set of REGs with a given numerology (e.g., SCS, CP length, etc.). A plurality of CORESETs for one UE may overlap in the time/frequency domain. The CORESET may be configured by system information (e.g., master information block (MIB)) or UE-specific higher layer signaling (e.g., radio resource control (RRC) layer signaling). Specifically, the numbers of RBs and OFDM symbols (up to three OFDM symbols) in the CORESET may be configured by higher layer signaling.

To receive/detect the PDCCH, the UE monitors PDCCH candidates. A PDCCH candidate refers to CCE(s) that the UE should monitor for PDCCH detection. Each PDCCH candidate is defined by 1, 2, 4, 8, or 16 CCEs depending on the AL. Here, monitoring includes (blind) decoding of PDCCH candidates. A set of PDCCH candidates monitored by the UE are defined as a PDCCH search space (SS). The SS may include a common search space (CSS) or a UE-specific search space (USS). The UE may obtain DCI by monitoring PDCCH candidates in one or more SSs, which are configured by an MIB or higher layer signaling. Each CORESET is associated with one or more SSs, and each SS is associated with one CORESET. The SS may be defined based on the following parameters.
controlResourceSetId: this indicates the CORESET related to the SS.
monitoringSlotPeriodicityAndOffset: this indicates a PDCCH monitoring periodicity (on a slot basis) and a PDCCH monitoring period offset (on a slot basis).
monitoringSymbolsWithinSlot: this indicates PDCCH monitoring symbols in a slot (e.g., first symbol(s) in the CORESET).
nrofCandidates: this denotes the number of PDCCH candidates for each AL={1, 2, 4, 8, 16} (one of 0, 1, 2, 3, 4, 5, 6, and 8).

* An occasion (e.g., time/frequency resource) for monitoring PDCCH candidates is defined as a PDCCH (monitoring) occasion. One or more PDCCH (monitoring) occasions may be configured in a slot.

Table 4 shows the characteristics of each SS.

TABLE 4

| | Search | | |
|---|---|---|---|
| Type | Space | RNTI | Use Case |
| Type0-PDCCH | Common | SI-RNTI on a | SIB Decoding |
| | | primary cell | |
| Type0A-PDCCH | Common | SI-RNTI on a | SIB Decoding |
| | | primary cell | |
| Type1-PDCCH | Common | RA-RNTI or TC-RNTI | Msg2, Msg4 |
| | | on a primary cell | decoding in |
| | | | RACH |
| Type2-PDCCH | Common | P-RNTI on a | Paging Decoding |
| | | primary cell | |
| Type3-PDCCH | Common | INT-RNTI SFI-RNTI, | |
| | | TPC-PUSCH-RNTI, | |
| | | TPC-PUCCH-RNTI, | |
| | | TPC-SRS-RNTI, C- | |
| | | RNTI, MCS-C-RNTI, | |
| | | or CS-RNTI(s) | |
| | UE | C-RNTI or MCS-C- | User specific |
| | Specific | RNTI, or CS-RNTI(s) | PDSCH decoding |

Table 5 shows DCI formats transmitted on the PDCCH.

TABLE 5

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the |
| | slot format |
| 2_1 | Notifying a group of UEs of the |
| | PRB(s) and OFDM symbols(s) where |
| | UE may assume no transmission is |
| | intended for the UE |
| 2_2 | Transmission of TPC commands for |
| | PUCCH and PUSCH |
| 2_3 | Transmission of a group of TPC commands |
| | for SRS transmissions by one or more UEs |

DCI format 0_0 may be used to schedule a TB-based (or TB-level) PUSCH, and DCI format 0_1 may be used to schedule a TB-based (or TB-level) PUSCH or a code block group (CBG)-based (or CBG-level) PUSCH. DCI format 1_0 may be used to schedule a TB-based (or TB-level) PDSCH, and DCI format 1_1 may be used to schedule a TB-based (or TB-level) PDSCH or a CBG-based (or CBG-level) PDSCH (DL grant DCI). DCI format 0_0/0_1 may be referred to as UL grant DCI or UL scheduling information, and DCI format 1_0/1_1 may be referred to as DL grant DCI or DL scheduling information. DCI format 2_0 is used to deliver dynamic slot format information (e.g., a dynamic slot format indicator (SFI)) to a UE, and DCI format 2_1 is used to deliver DL pre-emption information to a UE. DCI format 2_0 and/or DCI format 2_1 may be delivered to a corresponding group of UEs on a group common PDCCH which is a PDCCH directed to a group of UEs.

DCI format 0_0 and DCI format 1_0 may be referred to as fallback DCI formats, whereas DCI format 0_1 and DCI format 1_1 may be referred to as non-fallback DCI formats. In the fallback DCI formats, a DCI size/field configuration is maintained to be the same irrespective of a UE configuration. In contrast, the DCI size/field configuration varies depending on a UE configuration in the non-fallback DCI formats.

The PDSCH delivers DL data (e.g., a downlink shared channel (DL-SCH) transport block (TB)) and adopts a modulation scheme such as quadrature phase shift keying (QPSK), 16-ary quadrature amplitude modulation (16 QAM), 64-ary QAM (64 QAM), or 256-ary QAM (256 QAM). A TB is encoded to a codeword. The PDSCH may deliver up to two codewords. The codewords are individually subjected to scrambling and modulation mapping, and modulation symbols from each codeword are mapped to one or more layers. An OFDM signal is generated by mapping each layer together with a DMRS to resources, and transmitted through a corresponding antenna port.

The PUCCH delivers uplink control information (UCI). The UCI includes the following information.
SR: information used to request UL-SCH resources.
HARQ-ACK: a response to a DL data packet (e.g., codeword) on the PDSCH. An HARQ-ACK indicates whether the DL data packet has been successfully received. In response to a single codeword, a 1-bit of HARQ-ACK may be transmitted. In response to two codewords, a 2-bit HARQ-ACK may be transmitted. The HARQ-ACK response includes positive ACK (simply, ACK), negative ACK (NACK), discontinuous transmission (DTX) or NACK/DTX. The term “HARQ-ACK is interchangeably used with HARQ ACK/NACK and ACK/NACK.
CSI: feedback information for a DL channel. Multiple input multiple output (MIMO)-related feedback information includes an RI and a PMI.

Table 6 illustrates exemplary PUCCH formats. PUCCH formats may be divided into short PUCCHs (Formats 0 and 2) and long PUCCHs (Formats 1, 3, and 4) based on PUCCH transmission durations.

TABLE 6

| | Length in | | | |
|---|---|---|---|---|
| PUCCH | OFDM symbols | Number of | | |
| format | N_{symb}^{PUCCH} | bits | Usage | Etc |
| 0 | 1 · 2 | ≤2 | HARQ, SR | Sequence |
| | | | | selection |
| 1 | 4 · 14 | ≤2 | HARQ, [SR] | Sequence |
| | | | | modulation |
| 2 | 1 · 2 | >2 | HARQ, CSI, | CP-OFDM |
| | | | [SR] | |
| 3 | 4 · 14 | >2 | HARQ, CSI, | DFT-s-OFDM |
| | | | [SR] | (no UE |
| | | | | multiplexing) |
| 4 | 4 · 14 | >2 | HARQ, CSI, | DFT-s-OFDM |
| | | | [SR] | (Pre DFT OCC) |

PUCCH format 0 conveys UCI of up to 2 bits and is mapped in a sequence-based manner, for transmission. Specifically, the UE transmits specific UCI to the BS by transmitting one of a plurality of sequences on a PUCCH of PUCCH format 0. Only when the UE transmits a positive SR, the UE transmits the PUCCH of PUCCH format 0 in PUCCH resources for a corresponding SR configuration.

PUCCH format 1 conveys UCI of up to 2 bits and modulation symbols of the UCI are spread with an orthogonal cover code (OCC) (which is configured differently whether frequency hopping is performed) in the time domain. The DMRS is transmitted in a symbol in which a modulation symbol is not transmitted (i.e., transmitted in time division multiplexing (TDM)).

PUCCH format 2 conveys UCI of more than 2 bits and modulation symbols of the DCI are transmitted in frequency division multiplexing (FDM) with the DMRS. The DMRS is located in symbols #1, #4, #7, and #10 of a given RB with a density of 1/3. A pseudo noise (PN) sequence is used for a DMRS sequence. For 2-symbol PUCCH format 2, frequency hopping may be activated.

PUCCH format 3 does not support UE multiplexing in the same PRBS, and conveys UCI of more than 2 bits. In other words, PUCCH resources of PUCCH format 3 do not include an OCC. Modulation symbols are transmitted in TDM with the DMRS.

PUCCH format 4 supports multiplexing of up to 4 UEs in the same PRBS, and conveys UCI of more than 2 bits. In other words, PUCCH resources of PUCCH format 3 include an OCC. Modulation symbols are transmitted in TDM with the DMRS.

The PUSCH delivers UL data (e.g., UL-shared channel transport block (UL-SCH TB)) and/or UCI based on a CP-OFDM waveform or a DFT-s-OFDM waveform. When the PUSCH is transmitted in the DFT-s-OFDM waveform, the UE transmits the PUSCH by transform precoding. For example, when transform precoding is impossible (e.g., disabled), the UE may transmit the PUSCH in the CP-OFDM waveform, while when transform precoding is possible (e.g., enabled), the UE may transmit the PUSCH in the CP-OFDM or DFT-s-OFDM waveform. A PUSCH transmission may be dynamically scheduled by a UL grant in DCI, or semi-statically scheduled by higher-layer (e.g., RRC) signaling (and/or Layer 1 (L1) signaling such as a PDCCH) (configured scheduling or configured grant). The PUSCH transmission may be performed in a codebook-based or non-codebook-based manner.

On DL, the BS may dynamically allocate resources for DL transmission to the UE by PDCCH(s) (including DCI format 1_0 or DCI format 1_1). Further, the BS may indicate to a specific UE that some of resources pre-scheduled for the UE have been pre-empted for signal transmission to another UE, by PDCCH(s) (including DCI format 2_1). Further, the BS may configure a DL assignment periodicity by higher-layer signaling and signal activation/deactivation of a configured DL assignment by a PDCCH in a semi-persistent scheduling (SPS) scheme, to provide a DL assignment for an initial HARQ transmission to the UE. When a retransmission for the initial HARQ transmission is required, the BS explicitly schedules retransmission resources through a PDCCH. When a DCI-based DL assignment collides with an SPS-based DL assignment, the UE may give priority to the DCI-based DL assignment.

Similarly to DL, for UL, the BS may dynamically allocate resources for UL transmission to the UE by PDCCH(s) (including DCI format 0_0 or DCI format 0_1). Further, the BS may allocate UL resources for initial HARQ transmission to the UE based on a configured grant (CG) method (similarly to SPS). Although dynamic scheduling involves a PDCCH for a PUSCH transmission, a configured grant does not involve a PDCCH for a PUSCH transmission. However, UL resources for retransmission are explicitly allocated by PDCCH(s). As such, an operation of preconfiguring UL resources without a dynamic grant (DG) (e.g., a UL grant through scheduling DCI) by the BS is referred to as a “CG”. Two types are defined for the CG.
Type 1: a UL grant with a predetermined periodicity is provided by higher-layer signaling (without L1 signaling).
Type 2: the periodicity of a UL grant is configured by higher-layer signaling, and activation/deactivation of the CG is signaled by a PDCCH, to provide the UL grant.

Namely, with respect to UE's UL transmission, a UE may transmit a packet to transmit based on a dynamic grant or a pre-configured grant.

A resource for a grant configured for a plurality of UEs may be shared. A UL signal transmission based on a grant configured for each UE may be identified based on a time/frequency resource and a reference signal parameter (e.g., a different cyclic shift, etc.). Therefore, if a UE's UL transmission fails due to signal collision and the like, a BS may identify the corresponding UE and then explicitly transmit a retransmission grant for a corresponding transport block to the corresponding UE.

When there are multiple UEs having data to be transmitted on uplink/downlink in a wireless communication, a BS selects a UE that is to transmit data on a per transmission time internal (TTI) (e.g., slot) basis. In a system using multiple carriers or the like, the BS selects a

UE that is to transmit data on uplink/downlink on a per TTI basis and also selects a frequency band to be used by the UE for data transmission.

When description is based on uplink (UL), UEs transmit reference signals (or pilot signals) on uplink and the BS identifies channel states of the UEs using the reference signals transmitted from the UEs and selects a UE that is to transmit data on uplink in each unit frequency band per TTI. The BS notifies the UEs of the result of selection. That is, the BS transmits, to a UL scheduled UE, a UL assignment message indicating that the UE should transmit data using a specific frequency band in a specific TTI. The UL assignement message is also referred to as a UL grant. The UEs transmit data on uplink according to the UL assignment message. The UL assignment message may contain UE identity (ID), RB allocatioin information, a modulation and coding scheme (MCS), a redundancy version (RV), new data indication (NDI) and the like.

In the case of synchronous HARQ, a retransmission time is appointed in the system (e.g., after 4 subframes from a NACK reception time) (synchronous HARQ). Accordingly, the eNB may send a UL grant message to UEs only in initial transmission and subsequent retransmission is performed according to an ACK/NACK signal (e.g., PHICH signal). In the case of asynchronous HARQ, a retransmission time is not appointed and thus the eNB needs to send a retransmission request message to UEs. Further, frequency resources or an MCS for retransmission are identical to those in previous transmission in the case of non-adaptive HARQ, whereas frequency resources or an MCS for retransmission may differ from those in previous transmission in the case of adaptive HARQ. For example, in the case of asynchronous adaptive HARQ, the retransmission request message may contain UE ID, RB allocation information, HARQ process ID/number, RV, and NDI information because frequency resources or an MCS for retransmission vary with transmission time.

In NR, a dynamic HARQ-ACK codebook-based scheme and a semi-static HARQ-ACK codebook-based scheme are supported. The HARQ-ACK (or A/N) codebook may be replaced with a HARQ-ACK payload.

When the dynamic HARQ-ACK codebook-based scheme is configured, the size of the A/N payload varies according to the number of actually scheduled DL data. To this end, a counter-downlink assignment index (DAI) and a total-DAI are included in a PDCCH related to DL scheduling. The counter-DAI indicates a scheduling order value of {CC, slot} calculated in a

CC (component carrier) (or cell)-first manner, and is used to designate the position of an A/N bit in the A/N codebook. The total-DAI indicates a slot-based cumulative scheduling value up to the current slot, and is used to determine the size of the A/N codebook.

When the semi-static A/N codebook-based scheme is configured, the size of the A/N codebook is fixed (to the maximum value) regardless of the number of actually scheduled DL data. Specifically, the (maximum) A/N payload (size) transmitted on one PUCCH in one slot may be determined as the number of A/N bits corresponding to a combination of all CCs configured for the UE and all DL scheduling slots in which the A/N transmission timing may be indicated (or PDSCH transmission slots or PDCCH monitoring slots) (hereinafter, the combination is referred to as a bundling window). For example, DL grant DCI (PDCCH) may include PDSCH-to-A/N timing information. The PDSCH-to-A/N timing information may have one value (e.g., k) among a plurality of values. For example, when a PDSCH is received in slot #m, and PDSCH-to-A/N timing information in the DL grant DCI (PDCCH) for scheduling the PDSCH indicates k, the A/N information for the PDSCH may be transmitted in slot #(m+k). As an example, k∈{1, 2, 3, 4, 5, 6, 7, 8} may be given. On the other hand, when the A/N information is transmitted in slot #n, the A/N information may include the maximum possible A/N based on the bundling window. That is, the A/N information for slot #n may include A/N corresponding to slot #(n-k). For example, when k∈{1, 2, 3, 4, 5, 6, 7, 8}, the A/N information for slot #n includes A/Ns corresponding to slot #(n−8) to slot #(n−1) (i.e., the maximum number of A/Ns) regardless of actual reception of DL data. Here, the A/N information may be replaced with an A/N codebook or an A/N payload. Also, the slot may be understood/replaced as a candidate occasion for DL data reception. As an example, the bundling window may be determined based on the PDSCH-to-A/N timing with respect to the A/N slot, and the PDSCH-to-A/N timing set may have pre-defined values (e.g., {1, 2, 3, 4, 5, 6, 7, 8}), or may be configured by higher layer (RRC) signaling.

Recently, the 3GPP standardization organization is in the process of standardizing a 5G wireless communication system named NR (New RAT). The 3GPP NR system supports a plurality of logical networks in a single physical system and is designed to support services (e.g., eMBB, mMTC, URLLC, etc.) having various requirements by changing the transmission time interval (TTI) and OFDM numerology (e.g., OFDM symbol duration, subcarrier spacing (SCS)).

As data traffic has rapidly increased due to the recent emergence of smart devices, utilizing unlicensed bands for cellular communication in the 3GPP NR system is considered as in the licensed-assisted access (LAA) of the existing 3GPP LTE system. However, unlike the LAA, an NR cell in the unlicensed band (hereinafter, NR UCell) aims at a standalone (SA) operation. As an example, PUCCH, PUSCH, and PRACH transmissions may be supported in the NR UCell.

In an NR system to which various embodiments of the present disclosure are applicable, a frequency resource of up to 400 MHz may be allocated/supported per one component carrier (CC). When a UE configured operate in such a wideband CC always operates with a radio frequency (RF) module for the entire CCs turned on, battery consumption of the UE may increase.

Alternatively, considering various use cases (e.g., eMBB, URLLC, mMTC, and so on) operating within a single wideband CC, a different numerology (e.g., SCS) may be supported for each frequency band within the CC.

Alternatively, each UE may have a different maximum bandwidth capability.

In this regard, the BS may indicate to the UE to operate only in a partial bandwidth instead of the total bandwidth of the wideband CC. The partial bandwidth may be defined as a bandwidth part (BWP).

A BWP may be a subset of contiguous RBs on the frequency axis. One BWP may correspond to one numerology (e.g., SCS, CP length, slot/mini-slot duration, and so on).

The BS may configure multiple BWPs in one CC configured for the UE. For example, the BS may configure a BWP occupying a relatively small frequency area in a PDCCH monitoring slot, and schedule a PDSCH indicated (or scheduled) by a PDCCH in a larger BWP. Alternatively, when UEs are concentrated on a specific BWP, the BS may configure another BWP for some of the UEs, for load balancing. Alternatively, the BS may exclude some spectrum of the total bandwidth and configure both-side BWPs of the cell in the same slot in consideration of frequency-domain inter-cell interference cancellation between neighboring cells.

The BS may configure at least one DL/UL BWP for a UE associated with the wideband CC, activate at least one of DL/UL BWP(s) configured at a specific time point (by L1 signaling (e.g., DCI), MAC signaling, or RRC signaling), and indicate switching to another configured DL/UL BWP (by L1 signaling, MAC signaling, or RRC signaling). Further, upon expiration of a timer value (e.g., a BWP inactivity timer value), the UE may switch to a predetermined DL/UL

BWP. The activated DL/UL BWP may be referred to as an active DL/UL BWP. During initial access or before an RRC connection setup, the UE may not receive a configuration for a DL/UL BWP from the BS. A DL/UL BWP that the UE assumes in this situation is defined as an initial active DL/UL BWP.

Unlicensed Band System

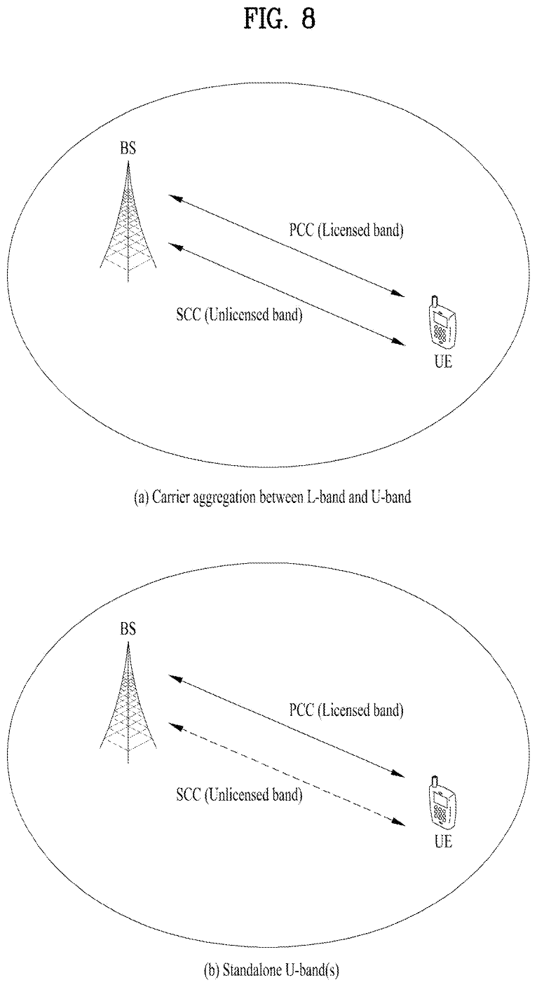

FIG. 8 illustrates an exemplary wireless communication system supporting an unlicensed band applicable to the present disclosure.

In the following description, a cell operating in a licensed band (L-band) is defined as an L-cell, and a carrier of the L-cell is defined as a (DL/UL) LCC. A cell operating in an unlicensed band (U-band) is defined as a U-cell, and a carrier of the U-cell is defined as a (DL/UL) UCC. The carrier/carrier-frequency of a cell may refer to the operating frequency (e.g., center frequency) of the cell. A cell/carrier (e.g., CC) is commonly called a cell.

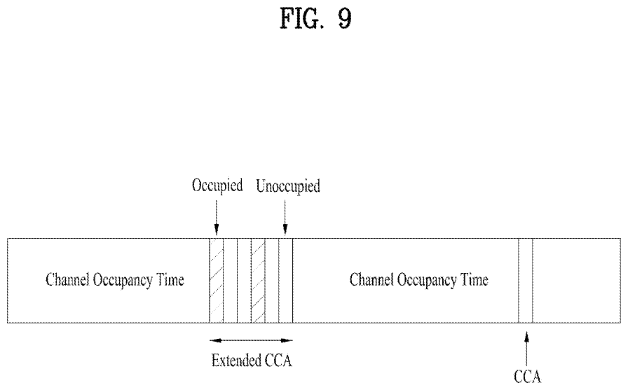

When carrier aggregation (CA) is supported, one UE may use a plurality of aggregated cells/carriers to exchange a signal with the BS. When one UE is configured with a plurality of CCs, one CC may be set to a primary CC (PCC), and the remaining CCs may be set to secondary CCs (SCCs). Specific control information/channels (e.g., CSS PDCCH, PUCCH) may be transmitted and received only on the PCC. Data may be transmitted and received on the PCC/SCC. FIG. 8(a) shows a case in which the UE and BS exchange signals on both the LCC and UCC (non-stand-alone (NSA) mode). In this case, the LCC and UCC may be set to the PCC and SCC, respectively. When the UE is configured with a plurality of LCCs, one specific LCC may be set to the PCC, and the remaining LCCs may be set to the SCC. FIG. 9(a) corresponds to the LAA of the 3GPP LTE system. FIG. 8(b) shows a case in which the UE and BS exchange signals on one or more UCCs with no LCC (stand-alone (SA) mode). In this case, one of the UCCs may be set to the PCC, and the remaining UCCs may be set to the SCC. Both the NSA mode and SA mode may be supported in the U-band of the 3GPP NR system.

FIG. 9 illustrates an exemplary method of occupying resources in an unlicensed band. According to regional regulations for the U-band, a communication node in the U-band needs to determine whether a corresponding channel is used by other communication node(s) before transmitting a signal. Specifically, the communication node may perform carrier sensing (CS) before transmitting the signal so as to check whether the other communication node(s) perform signal transmission. When the other communication node(s) perform no signal transmission, it is said that clear channel assessment (CCA) is confirmed. When a CCA threshold is predefined or configured by higher layer signaling (e.g., RRC signaling), if the detected channel energy is higher than the CCA threshold, the communication node may determine that the channel is busy. Otherwise, the communication node may determine that the channel is idle. When it is determined that the channel is idle, the communication node may start the signal transmission in the UCell. The Wi-Fi standard (802.11ac) specifies a CCA threshold of 62 dBm for non-Wi-Fi signals and a CCA threshold of −82 dBm for Wi-Fi signals. The sires of processes described above may be referred to as Listen-Before-Talk (LBT) or a channel access procedure (CAP). The LBT may be interchangeably used with the CAP.

In Europe, two LBT operations are defined: frame based equipment (FBE) and load based equipment (LBE). In FBE, one fixed frame is made up of a channel occupancy time (e.g., 1 to 10 ms), which is a time period during which once a communication node succeeds in channel access, the communication node may continue transmission, and an idle period corresponding to at least 5% of the channel occupancy time, and CCA is defined as an operation of observing a channel during a CCA slot (at least 20 us) at the end of the idle period. The communication node performs CCA periodically on a fixed frame basis. When the channel is unoccupied, the communication node transmits during the channel occupancy time, whereas when the channel is occupied, the communication node defers the transmission and waits until a CCA slot in the next period.

In LBE, the communication node may set q∈{4, 5, . . . , 32} and then perform CCA for one CCA slot. When the channel is unoccupied in the first CCA slot, the communication node may secure a time period of up to (13/32)q ms and transmit data in the time period. When the channel is occupied in the first CCA slot, the communication node randomly selects NE {1, 2, . . . , q}, stores the selected value as an initial value, and then senses a channel state on a CCA slot basis. Each time the channel is unoccupied in a CCA slot, the communication node decrements the stored counter value by 1. When the counter value reaches 0, the communication node may secure a time period of up to (13/32)q ms and transmit data.

The BS may perform one of the following unlicensed band access procedures (e.g., channel access procedures (CAPs)) to transmit a DL signal in the unlicensed band.

(1) First DL CAP Method

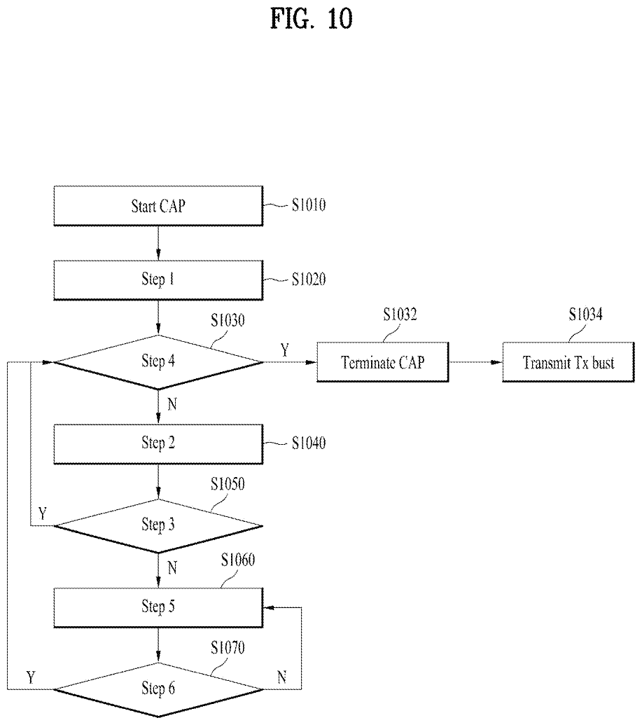

FIG. 10 is a flowchart illustrating a DL CAP for DL signal transmission in an unlicensed band, performed by a BS.

For DL signal transmission (e.g., transmission of a DL signal such as a PDSCH/PDCCH/enhanced PDCCH (EPDCCH)), the BS may initiate a CAP (S1010). The BS may randomly select a backoff counter N within a contention window (CW) according to step 1. N is set to an initial value Nᵢₙᵢₜ (S1020). Nᵢₙᵢₜ is a random value selected from the values between 0 and CWₚ. Subsequently, when the backoff counter value N is 0 according to step 4 (S1030; Y), the BS terminates the CAP (S1032). The BS may then perform a Tx burst transmission including transmission of a PDSCH/PDCCH/EPDCCH (S1034). On the contrary, when the backoff counter value N is not 0 (S1030; N), the BS decrements the backoff counter value by 1 according to step 2 (S1040). Subsequently, the BS checks whether the channel of U-cell(s) is idle (S1050). If the channel is idle (S1050; Y), the BS determines whether the backoff counter value is 0 (S1030). On the contrary, when the channel is not idle, that is, the channel is busy (S1050; N), the BS determines whether the channel is idle during a longer defer duration T_{d} (25 usec or longer) than a slot duration (e.g., 9 usec) according to step 5 (S1060). If the channel is idle during the defer duration (S1070; Y), the BS may resume the CAP. The defer duration may include a 16-usec duration and the immediately following mₚ consecutive slot durations (e.g., each being 9 usec). On the contrary, if the channel is busy during the defer duration (S1070; N), the BS re-checks whether the channel of the U-cell(s) is idle during a new defer duration by performing step S1060 again.

Table 7 illustrates that mₚ, a minimum CW, a maximum CW, a maximum channel occupancy time (MCOT), and an allowed CW size applied to a CAP vary according to channel access priority classes.

TABLE 7

| Channel | | | | | |
|---|---|---|---|---|---|
| Access | | | | | |
| Priority | | | | | Allowed |
| Class (p) | mₚ | CW_{min, p} | CW_{max, p} | T_{ultcot, p} | CWₚ sizes |
| 1 | 1 | 3 | 7 | 2 ms | {3, 7} |
| 2 | 1 | 7 | 15 | 3 ms | {7, 15} |
| 3 | 3 | 15 | 63 | 8 or 10 ms | {15, 31, 63} |
| 4 | 7 | 15 | 1023 | 8 or 10 ms | {15, 31, 63, |
| | | | | | 127, 255, 511, |
| | | | | | 1023} |

A CW size applied to the first DL CAP may be determined in various methods. For example, the CW size may be adjusted based on the probability of HARQ-ACK values corresponding to PDSCH transmission(s) within a predetermined time period (e.g., a reference TU) being determined as NACK. In the case where the BS performs a DL transmission including a PDSCH that is associated with a channel access priority class p on a carrier, if the probability z of HARQ-ACK values corresponding to PDSCH transmission(s) in reference subframe k (or reference slot k) being determined as NACK is at least 80%, the BS increases a CW value set for each priority class to the next higher allowed value. Alternatively, the BS maintains the CW value set for each priority class to be an initial value. A reference subframe (or reference slot) may be defined as the starting subframe (or slot) of the most recent transmission on the carrier made by the BS, for which at least some HARQ-ACK feedback is expected to be available.

(2) Second DL CAP Method

The BS may perform a DL signal transmission (e.g., a signal transmission including a discovery signal transmission, without a PDSCH) in an unlicensed band according to the second DL CAP method described below.

When the signal transmission duration of the BS is equal to or less than 1 ms, the BS may transmit a DL signal (e.g., a signal including a discovery signal without a PDSCH) in the unlicensed band immediately after sensing the channel to be idle for at least a sensing duration T_{drs}=25 us. T_{drs} includes a duration T_{f} (=16 us) following one sensing slot duration Tₛₗ (=9 us).

(3) Third DL CAP Method

The BS may perform the following CAPs for DL signal transmission on multiple carriers in an unlicensed band.

1) Type A: The BS performs a CAP for multiple carriers based on a counter N defined for each carrier (a counter N considered in a CAP) and performs a DL signal transmission based on the CAP.
Type A1: The counter N for each carrier is determined independently, and a DL signal is transmitted on each carrier based on the counter N for the carrier.
Type A2: The counter N of a carrier with a largest CW size is set for each carrier, and a DL signal is transmitted on each carrier based on the counter N for the carrier.

2) Type B: The BS performs a CAP based on a counter N only for a specific one of a plurality of carriers and performs a DL signal transmission by checking whether the channels of the other carriers are idle before a signal transmission on the specific carrier.
Type B1: A single CW size is defined for a plurality of carriers, and the BS uses the single CW size in a CAP based on the counter N for a specific carrier.
Type B2: A CW size is defined for each carrier, and the largest of the CW sizes is used in determining Nᵢₙᵢₜ for a specific carrier.

Further, the UE performs a contention-based CAP for a UL signal transmission in an unlicensed band. The UE performs a Type 1 or Type 2 CAP for the UL signal transmission in the unlicensed band. In general, the UE may perform a CAP (e.g., Type 1 or Type 2) configured for a UL signal transmission by the BS.

(1) Type 1 UL CAP Method

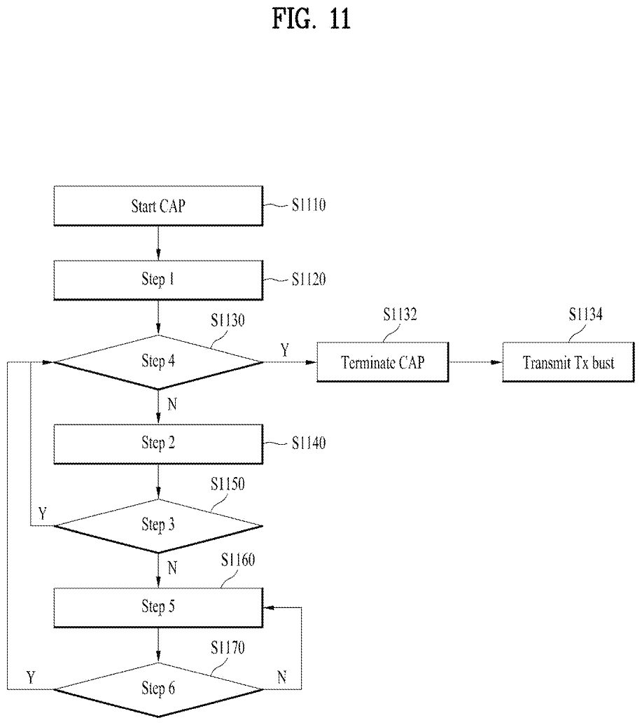

FIG. 11 is a flowchart illustrating UE's Type 1 CAP operation for UL signal transmission.

To transmit a signal in the U-band, the UE may initiate a CAP (S1110). The UE may randomly select a backoff counter N within a contention window (CW) according to step 1. In this case, N is set to an initial value Nᵢₙᵢₜ (S1120). Nᵢₙᵢₜ may have a random value between 0 and CWₚ. If it is determined according to step 4 that the backoff counter value (N) is 0 (YES in S1130), the UE terminates the CAP (S1132). Then, the UE may perform Tx burst transmission (S1134). If the backoff counter value is non-zero (NO in S1130), the UE decreases the backoff counter value by 1 according to step 2 (S1140). The UE checks whether the channel of U-cell(s) is idle (S1150). If the channel is idle (YES in S1150), the UE checks whether the backoff counter value is 0 (S1130). On the contrary, if the channel is not idle in S1150, that is, if the channel is busy (NO in S1150), the UE checks whether the corresponding channel is idle for a defer duration T_{d} (longer than or equal to 25 usec), which is longer than a slot duration (e.g., 9 usec), according to step 5 (S1160). If the channel is idle for the defer duration (YES in S1170), the UE may resume the CAP. Here, the defer duration may include a duration of 16 usec and mₚ consecutive slot durations (e.g., 9 usec), which immediately follows the duration of 16 usec. If the channel is busy for the defer duration (NO in S1170), the UE performs step S1160 again to check whether the channel is idle for a new defer duration.

Table 8 shows that the values of mₚ, a minimum CW, a maximum CW, an MCOT, and allowed CW sizes, which are applied to the CAP, vary depending on channel access priority classes.

TABLE 8

| Channel | | | | | |
|---|---|---|---|---|---|
| Access | | | | | |
| Priority | | | | | allowed |
| Class (p) | mₚ | CW_{min, p} | CW_{max, p} | T_{ulmcot, p} | CWₚ sizes |
| 1 | 2 | 3 | 7 | 2 ms | {3, 7} |
| 2 | 2 | 7 | 15 | 4 ms | {7, 15} |
| 3 | 3 | 15 | 1023 | 6 ms or 10 ms | {15, 31, 63, |
| | | | | | 127, 255, 511, |
| | | | | | 1023} |
| 4 | 7 | 15 | 1023 | 6 ms or 10 ms | {15, 31, 63, |
| | | | | | 127, 255, 511, |
| | | | | | 1023} |

The size of a CW applied to the Type 1 UL CAP may be determined in various ways. For example, the CW size may be adjusted depending on whether the value of of a new data indicator (NDI) for at least one HARQ process associated with HARQ_ID_ref, which is the HARQ process ID of a UL-SCH in a predetermined time period (e.g., a reference TU), is toggled. When the UE performs signal transmission using the Type 1 CAP associated with the channel access priority class p on a carrier, if the value of the NDI for the at least one HARQ process associated with HARQ_ID_ref is toggled, the UE may set CWₚ to CW_{min, p} for every priority class P∈{1, 2, 3, 4}. Otherwise, the UE may increase CWₚ for every priority class p∈{1, 2, 3, 4} to a next higher allowed value.

A reference subframe (or reference slot) n_{ref} may be determined as follows.

When the UE receives a UL grant in a subframe (or slot) n_{g} and performs transmission including a UL-SCH, which has no gaps and starts from a subframe (or slot) no, in subframes (or slots) n₀, n₁, . . . , n_{w} (here, the subframe (or slot) n_{w} is the most recent subframe (or slot) before a subframe n_{g}-3 in which the UE has transmitted the UL-SCH based on the Type 1 CAP), the reference subframe (or slot) n_{ref} may be the subframe no.

(2) Type 2 UL CAP Method

When the UE uses the Type 2 CAP to transmit a UL signal (including the PUSCH) in a U-band, the UE may transmit the UL signal (including the PUSCH) in the U-band immediately after sensing that the channel is idle at least for a sensing period T_{short_ul} of 25 us. T_{short_ul} includes a duration T_{f} of 16 us immediately followed by one slot duration Tₛₗ of 9 us. T_{f} includes an idle slot duration Tₛₗ at the start thereof.

In NR-U, when the BW of a BWP assigned to the BS or UE is greater than or equal to 20 MHz, the BWP may be divided by an integer multiple of 20 MHz for fair coexistence with Wi-Fi to perform LBT in units of 20 MHz and transmit each signal. A frequency unit in which LBT is performed is referred to as a channel or an LBT sub-band. 20 MHz has a meaning as a frequency unit in which LBT is performed, and various embodiments of the present disclosure are not limited to a specific frequency value such as 20 MHz.

In some implementations, the proposed method of the present disclosure is non-limited to an LBT based U-band operation only but is similarly applicable to an L-band (or U-band) operation not accompanied by LBT. In the following description, a band may be compatible with a CC/cell. Moreover, a CC/cell (index) may be replaced by a BWP (index) configured in the CC/cell or a combination of a CC/cell (index) and a BWP (index). In the following description, HARQ-ACK will be referred to as A/N for convenience.

First of all, terms are defined as follows.
UL grant DCI: This means a DCI for a UL grant. For example, it means a DCI format 0_0 or 0_1 and is transmitted on PDCCH.
DL assignment/grant DCI: This means a DCI for a DL grant. For example, it means a DCI format 1_0 or 1_1 and is transmitted on PDCCH.
PUSCH: This means a physical layer UL channel for UL data transmission.
Slot: This means a basic Time Unit (TU) or time interval for data scheduling. A slot includes a plurality of symbols. Here, a symbol includes an OFDM-based symbol (e.g., CP-OFDM symbol, DFT-s-OFDM symbol). In the present specification, a symbol, an OFDM-based symbol, an OFDM symbol, a CP-OFDM symbol and a DFT-s-OFDM symbol may be substituted with each other.
Channel: This may mean a carrier or a part of a carrier configured with a contiguous set of RBs on which a channel access procedure is performed in a shared spectrum. For example, it may mean a frequency unit on which LBT is performed and be interchangeably usable with an LBT subband in the following description.
Performing LBT for/on a channel X: It means that LBT is performed to check whether the channel X can be transmitted. For example, a CAP procedure (e.g., see FIG. 11) may be performed before a transmission of the channel X starts.

Perform LBT in/for/on a symbol X: This means that LBT is performed to check whether a transmission can start in symbol X. For example, a CAP procedure (e.g., see FIG. 11) may be performed in symbol(s) previous to a symbol X.

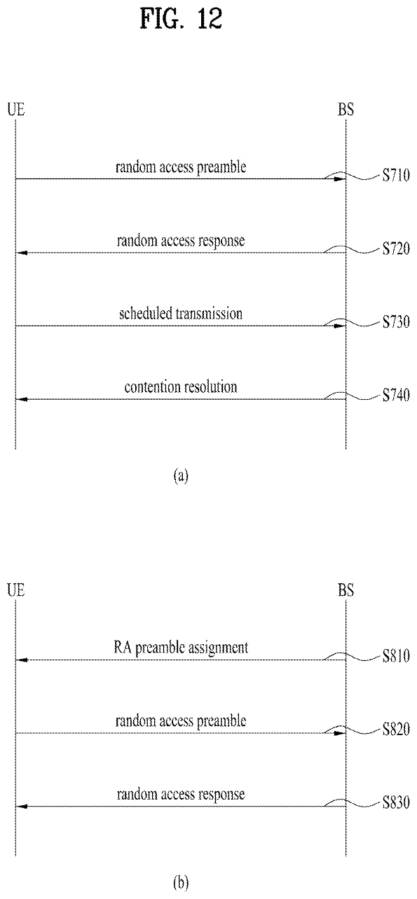

FIG. 12 is a diagram showing a general random access process.

A random access process is used for various usages. For example, a random access process may be used for network initial access, handover, and UE-triggered UL data transmission. A UE may obtain UL synchronization and UL transmission resource via the random access process. The random access process is divided into a contention-based process and a non-contention based (or dedicated) process. The random access process is interchangeably usable with a Random Access Channel (RACH) process.

FIG. 12 (a) shows an example of a contention-based random access process.

Referring to FIG. 12 (a), a UE receives information on a random access from a BS via system information. Thereafter, if the random access is necessary, the UE transmits a random access preamble Msg1 to the BS [S710]. If the BS receives the random access preamble from the UE, the BS transmits a Random Access Response (RAR) message Msg2 to the UE [S720]. Particularly, scheduling information on the random access response message may be CRC-masked with a Random Access-RNTI (RA-RNTI) and then transmitted on L1/L2 control channel (PDCCH). The PDCCH masked with the RA-RNTI may be transmitted through a common search space only. In case of receiving a scheduling signal masked with RA-RNTI, the UE may receive a random access response message from PDSCH indicated by the scheduling information. Thereafter, the UE checks whether random access response information indicated to the UE exists in the random access response message. Whether random access response information indicated to the UE exists may be confirmed based on whether a Random Access preamble ID (RAID) for a preamble transmitted by the UE exists. The random access response information includes timing offset information for UL synchronization (e.g., Timing Advance Command (TAC), UL scheduling information (e.g., UL grant), and UE temporary identification information (e.g., Temporary-C-RNTI (TC-RNTI). If receiving the random access response information, the UE transmits UL-Shared Channel (UL-SCH) data Msg3 on PUSCH according to UL scheduling information [S730]. After receiving the UL-SCH data, the BS transmits a contention resolution message Msg4 to the UE [S740].

FIG. 12 (b) shows a non-contention based random access process. The non-contention based random access process may be used for a handover process or exist if requested by a command from a BS. A basic process is identical to a contention-based random access process.

Referring to FIG. 12 (b), a dedicated random access preamble is assigned to a UE from a BS [S810]. Dedicated random preamble indication information (e.g., preamble index) may be included in an RRC message (e.g., handover command) or received via PDCCH order. After initiation of a random access process, the UE transmits a dedicated random access preamble to the BS [S820]. Thereafter, the UE receives a random access response from the BS [S830] and the random access process ends. The random access process on SCell may be initiated by the PDCCH order only.

In NR, to initiate a non-contention based random access process by a PDCCH order, DCI format 1_0 is used. The DCI format 1_0 is sued to schedule PDSCH in a single DL cell. Meanwhile, if a Cyclic Redundancy Check (CRC) of DCI format 1_0 is scrambled with C-RNTI and a bit value of ‘frequency domain resource assignment’ is 1 all, DCI format 1_0 is used as a PDCCH order indicating a random access process. In this case, a field of DCI format 1_0 is configured as follows.
RA preamble index: 6 bits
UL/Supplementary UL (UL/SUL) indicator: 1 bit. If a bit value of an RA preamble index is non-zero all and SUL is configured within a cell for a UE, this indicator indicates a UL carrier having carried PRACH in the cell. Otherwise, this indicator is reserved.
SSB index: If a bit value of an RA preamble index is non-zero all, this index indicates SSB used to determine an RACH occasion for PRACH transmission. Otherwise, this index is reserved.
PRACH mask index: 4 bits. If a bit value of an RA preamble index is non-zero all, this index indicates an rACH occasion associated with SSB indicated by an SSB index. Otherwise, this index is reserved.
Reserved: 10 bits.

If DCI format 1_0 fails to correspond to PDCCH order, DCI format 1_0 is constructed with a field used to schedule PDSCH (e.g., time domain resource assignment, Modulation and Coding Scheme (MCS), HARQ process number, PDSCH-to-HARQ feedback timing indicator, etc.).

To support a standalone operation on U-band, a random access process based on PRACH transmission on UE's U-band may be necessary. To this end, it may consider performing a series of operations such as PRACH transmission/retransmission, RAR reception, Msg3 transmission/retransmission and MSg4 reception, like the existing Licensed band (L-band) via a Component Carrier (CC). Yet, due to the characteristics of U-band operation based on occasional radio channel occupation via CAP (channel access procedure, or LBT (listen before talk), or CCA (clear channel assessment)), it is possible that such a single CC based random access process may considerably increase access latency (hereinafter, CAP, LBT or CCA will be commonly referred to as LBT).

A single CC or BandWidth Part (BWP) configured for a UE in U-band situation may be configured with a wideband CC/BWP having a BandWidth (BW) greater than that of the legacy LTE. Meanwhile, in a wideband CC/BWP configuration situation, a BW for which CCA based on an independent LBT operation is required, may be limited based on a specific regulation. Hence, if a unit subband on which an individual LBT is performed is defined as LBT-SB, a plurality of LBT-SBs may be included in a single wideband CC/BWP.

Accordingly, the present disclosure proposes a random access process based on a plurality of CCs and a relevant UE operation to reduce access latency due to LBT on U-band. The proposed method of the present disclosure is non-limited to a general random access process only but may be similarly applicable to a beam failure recovery process (using a PRACH (preamble) signal or an SR (PUCCH) signal) and a request operation therefor. In addition, the proposed method of the present disclosure is non-limited to an LBT based U-band operation only but may be similarly applicable to an L-band (or U-band) operation not accompanied by LBT.

In the following description, a plurality of CCs (or a plurality of CC indexes) may be substituted with: 1) a plurality of BWPs configured in one or more CCs or a (serving) cell (or a plurality of BWP indexes); 2) a plurality of LBT-SBs (or a plurality of LBT-SB indexes) configured in one or more CCs or BWPs; or 3) a plurality of CCs/cells/BWPs configured with a plurality of BWPs or a plurality of LBT-SBs (i.e., a combination of CC (index) and/or BWP (index) and/or LBT-SB (index)), and in such a state, the proposed principle/operation of the present disclosure is applicable identically. Moreover, in the following description, PRACH or Msg3 may be substituted with an SR signal (e.g., PUCCH), an Sounding Reference Signal (SRS), an SPS (semi persistent scheduling) or grant-free type data signal, and in such a state, the proposed principle/operation of the present disclosure (e.g., LBT target CC selecting method, UL transmission CC configuration mode, etc.) may be identically applicable. Prior to the proposal description, parameters and notations accompanied by a random access process according to an embodiment of the present disclosure are described as follows.

1) Parameter Definition

A. Number of PRACH preamble/resource configured CCs (e.g., total CC number in network: N (multiple)

B. Number of CCs available for simultaneous LBT execution: K (one or multiple)

C. Number of CCs available for simultaneous PRACH transmission: L (one or multiple)

D. Number of CCs succeeding in LBT among K ccs: M (where K>=M)

2) Notation Definition

A. SS/BCH CC: CC via which a UE detects/receives a synchronization signal or BCH

(Hereinafter, SS/BCH, SSB or SS/PBCH is used as the same meaning.)

B. PRACH CC: CC on which a UE performs PRACH preamble signal transmission

C: RAR CC: CC via which a UE detects/receives RAR (PDSCH)

D: Msg3 CC: CC on which a UE performs Msg3 (PUSCH) transmission

E: Msg 4 CC: CC via which a UE detects/receives Msg4 (PDSCH)

Each proposal described below may be combined and applied together unless it is contrary to other proposals.

(1) Step 1: LBT target CC (or CC group) selecting method

As a method for a UE to select an LBT target CC (or CC group) for PRACH transmission, at least one of the following options may be considered.

1) Opt 1-1: CC group having SS/BCH CC in center of LBT BW

A. Centering around SS/BCH CC, a CC group included in a bandwidth amounting to a size of LBT-capable BW (LBT-capable band or the number of LBT-SBs corresponding thereto) may be selected as an LBT target.

For example, a carrier included in a bandwidth amounting to LBT-capable BW (or the number of LBT-SBs corresponding thereto) centering around a synchronization signal block carrier may become an LBT target carrier.

2) Opt 1-2: CC group providing better RSRP (if detecting multiple SS/BCH CCs)

A. In a state that a UE has detected/received a plurality of SS/BCH CCs, a CC group including a cC providing the best RSRP or a CC group having the beast average RSRP may be selected as an LBT target.

3) Opt 1-3: CC group having the CC with nearest PRACH timing

A. A CC group including a CC with the nearest PRACH transmission timing from an SS/BCH detection/reception/decoding timing may be selected as an LBT target.

For example, a CC group including a CC having a preset PRACH transmission time set nearest to a synchronization signal block detected/received/decoded timing may become an LBT target.

4) Opt 1-4: Random selection or formula based selection (using at least one of UE ID, cell ID, time domain index, or frequency domain index)

A. Specific K CCs among total N CCs may be selected as an LBT target by a random scheme or based on a specific formula.

The random scheme or formula may be determined as a function of at least one of UE ID (e.g., International Mobile Subscriber Identity (IMSI), C-RNTI, etc.), cell ID, time domain index (e.g., slot index configured for PRACH transmission), and frequency domain index (e.g., PRB index configured for PRACH transmission).

B. In addition, a probability of selecting a corresponding CC for each of N CCs as an LBT target (and/or a PRACH transmission target) may be configured (via SIB, etc.), whereby a UE may operate to perform an LBT target CC (and/or PRACH transmission target CC) selection by applying the above probability.

5) Opt 1-5: configured by RRC (only for SR after RRC connection)

A. An LBT target CC group may be configured via (UE-specific) RRC signaling.

6) Opt 1-6: indicated by PDCCH order (candidate CC group or random selection)

A. An LBT target CC group may be designated via L1 signaling such as PDCCH order or the like. A specific CC group becoming an LBT target may be designated via PDCCH or application of the Opt 1-4 (random selection or formula based selection) may be indicated.

7) Opt 1-7: CC group having maximum number of PRACH-configured CCs

A. A CC group may be selected in a manner that the most PRACH-configured CCs are included in an LBT-capable BW.

8) Opt 1-8: signaled by UE-common PDCCH or signal (candidate CC group or random selection)

A. An LBT target CC group may be periodically signaled via a specific UE-common channel/signal (e.g., PDCCH, preamble). A UE may determine a signaled CC group as an LBT target for PRACH transmission until receiving a next UE-common channel/signal. Via a UE-common channel/signal, an LBT target CC group may be designated or the application of the Opt 1-4 may be indicated.

Meanwhile, as operations accompanied at the Step-1 performing timing and before and after the corresponding timing, the following matters s may be considered.

1) Associated operation 1

A. PRACH configuration information (PRACH preamble/resource configuration) on a plurality of CCs (e.g., N CCs) may be delivered via system information (i.e., System Information Block (SIB)) transmitted on a single SS/BCH CC. The SS/BCH CC may be configured as an RSRP (or pathloss estimate) reference carrier (reference CC) for a plurality of PRACH-configured CCs. For example, in idle mode, a UE may receive information on LBT target CCs (CCs capable of PRACH transmission) via SIB.

B. SS/BCH CC may be configured as PRACH Transmission (PRACH TX) timing reference CC with respect to a plurality of the PRACH-configured CCs.

C. Meanwhile, in the description above or below, SS/BCH CC may be substituted with SS/BCH transmitted (initial) DL BWP and PRACH-configured CC may be substituted with PRACH resource/transmission configured/allowed (initial) UL BWP via SS/BCH CC or DL BWP.

2) Associated operation 2

A. An LBT target CC group may be basically selected/configured to include SS/BCH CC (if a PRACH resource is configured for the corresponding CC) at all times.

3) Associated operation 3

A. If failing in LBT for all CCs within a CC group, it may operate to attempt LBT again while maintaining an LBT target CC group (e.g., if an Energy Detection (ED) level is equal to or lower than a predetermined level), or attempt LBT again after changing an LBT target CC group (e.g., if the ED level is higher that the predetermined level).

4) Associated operation 4

A. IF N≤K, all of N CCs may be determined as an LBT target without a separate selection process. Namely, only if N>K, a procedure for selecting an LBT target CC or an LBT target CC group may be necessary.

5) Associated operation 5

A. Meanwhile, LBT capability (e.g., K) capable of performing LBT simultaneously and/or UL TX capability (e.g., L) capable of transmitting PRACH simultaneously may be determined as a different value between UEs (e.g., K>1 & L>1 in case of UE1, K>1 & L=1 in case of UE2, and K=L=1 in case of UE3).

B. Therefore, considering a random access process) in a situation that UEs having different capabilities are mixed (in this case, RAR and/or Msg3 corresponding to a different UE is sorted), at least one of sequence generation for PRACH signal configuration, frequency index for PRACH resource regulation (and corresponding RA-RNTI value determination, scrambling seed for Msg3 PUSCH signal generation, and sequence generation for Msg3 DMRS signal configuration may be determined using the following information.
Frequency resource (e.g., RB) index in the full PRACH preamble/resource configured UL bandwidth (i.e., aggregated UL BW, e.g., full frequency band across N CCs) (not with reference to selected CC(s))
Frequency resource (e.g., RB) index in reference UL BW including PRACH preamble/resource configured BW/band (pre-configured via SIB or the like in advance)

(2) Step 2: PRACH TX Target CC (or CC Group) Selecting Method

As a method of selecting a PRACH TX target CC (or CC group) from CCs having succeeded in LBT in Step 1, at least one of the following options may be considered.

1) Opt 2-1: according to LBT result (with lowest ED level)

A. CCs with lowest ED level) according to LBT may be selected as a PRACH TX target.

2) Opt 2-2: close to SS/BCH CC (CC providing similar RSRP to the SS/BCH CC)

A. CCs nearest to SS/BCH CC on frequency may be selected as a PRACH TX target.

For example, if frequency is near to an SS/BCH CC, RSRP may be measured similar to the SS/BCH CC. A CC having RSRP similar to an SS/BCH CC is identified as a CC near to the SS/BCH CC on frequency and may become a PRACH TX target CC.

3) Opt 2-3: based on RSRP (if detecting multiple SS/BCH CCs)

A. In a state that a UE has detected/received a plurality of SS/BCH CCs, CCs providing the better RSRP may be selected as a PRACH TX target.

4) Opt 2-4: according to PRACH resource (with nearest timing)

A. A CC having a PRACH TX timing configured nearest from an LBT execution timing may be selected.

5) Opt 2-5: random selection or formula based selection

A. A UE may select specific L CCs from M CCs having succeeded in LBT by a random scheme or based on a specific formula. The scheme/formula may be determined as a function of at least one of UE ID, cell ID, time domain index, and frequency domain index.

B. Additionally, a probability of selecting a corresponding CC as a PRACH TX target for each CC may be pre-configured in advance (via SIB or the like), and a UE may select a CC by applying the probability.

Meanwhile, as operations accompanied at a Step-2 execution timing and before and after the corresponding timing, the following matters may be considered.

1) Associated operation 1

A. PRACH signal power transmitted via the CC group selected by applying the above option may be configured based on RSRP (or pathloss estimate) on SS/BCH CC. The PRACH power based on the RSRP (or pathloss estimate) itself may be configured identically for all CCs, or a power offset may be added (to the RSRP (or pathloss estimate) based PRACH power) depending on a relative position (on frequency) from SS/BCH CC.

B. A start point of a PRACH signal transmitted via the CC group may be determined with reference to a DL signal reception timing (e.g., slot or symbol boundary) on the SS/BCH CC.

C. Meanwhile, the SS/BCH CC described above or below may be substituted with (initial) DL BWP on which an SS/BCH is transmitted, and a PRACH TX target CC may be substituted with (initial) UL BWP configured/allowed for PRACH resource/transmission via SS/BCH or DL BWP.

2) Associated operation 2

A. A UE may perform simultaneous transmission of multiple PRACHs on multiple CCs according to UE capability (for an L value). Thereafter, the UE may operate to perform transmission via a single CC only for Msg3 or perform simultaneous transmission for multiple Msg3s via multiple CCs.

3) Associated operation 3

A. If M≤L, all M CCs may be determined as a PRACH Tx target without a separate selection process. Namely, only if M>L, a procedure for selecting a PRACH TX target CC or a PRACH TX target CC group may be necessary.

A PRACH TX target CC may be selected as a CC other than an SS/BCH CC.

(3) Step 3: RAR Reception (RX) CC configuring method

As a method of configuring an RAR RX CC corresponding to PRACH transmission via the CC group selected in Step 2, at least one of the following options may be considered.

1) Opt 3-1: SS/BCH CC

A. RAR detection/reception may be performed via SS/BCH CC.

2) Opt 3-2: PRACH CC

A. RAR detection/reception may be performed via PRACH CC.

3) Opt 3-3: Pre-Configured by SIB or RRC (paring between PRACH CC and RAR CC)

A. Information of PRACH CC and RARCC (or candidate RAR CC group) corresponding to the PRACH CC may be pre-configured in advance via SIB or RRC signaling.

4) Opt 3-4: indicated by PDCCH order (RAR CC or candidate CC group)

A. Information on an RAR received CC or a candidate RAR CC group capable of RAR reception may be specified via L1 signaling such as PDCCH order and the like.

5) Opt 3-5: try to detect RAR over multiple CCs (including SS/BCH CC or PRACH CC)

A. RAR detection/reception may be performed via a specific group configured with multiple CCs (or a random CC in the CC group), and the CC group may be configured to include at least SS/BCH CC and/or PRACH CC.

Meanwhile, as operations accompanied at a Step-3 execution timing and before and after the corresponding timing, the following matters may be considered.

1) Associated operation 1

A. If an RAR RX CC is configured with a CC group, i.e., multiple CCs in the above option, a UE may operate to attempt detection/reception of RAR (and PDCCH of scheduling the RAR) over the multiple CCs.

2) Associated operation 2

A. A PRACH CC index may be transmitted by being included in RAR PDSCH (e.g., in form of a MAC (sub-)header or indicated via PDCCH corresponding to RAR, or an RA-RNTI value may be determined using the PRACH CC index.

An RAR CC may be selected as a CC other than an SS/BCH CC or a CC other than a PRACH CC.

(4) Step 4: PRACH retransmission CC selecting method (LBT target CC included)

As a method of selecting a CC for PRACH retransmission (and an LBT target for the PRACH retransmission) in case of: (i) failure in RAR reception; ii) failure in Msg4 despite transmission/retransmission of Msg3; or iii) failure in Contention Resolution (CR) despite reception of Msg4, at least one of the following options may be considered.

1) Opt 4-1: keep initial PRACH CC (or CC group including the CC)

A. A UE may select a CC on which a previous PRACH (initial) transmission has been performed as a retransmission (and LBT target) CC.

2) Opt 4-2: change to different CC (group) from initial PRACH CC (group)

A. A UE may select a CC (or CC group) other than a CC (or CC group) on which a previous PRACH (initial) transmission was performed as a PRACH retransmission (and LBT target) CC.

3) Opt 4-3: just go to Step 1/2 in above

A. It is able to select a PRACH retransmission (and LBT target) CC by applying Step 1 or Step 2.

4) Opt 4-4: try LBT for initial PRACH CC (group) then apply Opt 4-2 or Opt 4-3 if LBT is failed

A. A UE attempts LBT on a CC (or CC group) on which a previous PRACH (initial) transmission was performed. If succeeding in the attempt, the UE may apply Opt 4-1. If failing in the attempt, the UE may apply Opt 4-2 or Opt 4-3.

Meanwhile, as operations accompanied at a Step-4 execution timing and before and after the corresponding timing, the following matters may be considered.

1) Associated operation 1

A. If the previous PRACH (initial) transmission CC is selected as a retransmission CC in the above option, a PRACH TX counter value is incremented. If a CC other than the previous PRACH (initial) transmission CC is selected as a retransmission CC, the PRACH TX counter value may not be incremented (or, a PRACH TX counter may be independently operated per CC).

A PRACH TX counter counts a PRACH TX count, i.e., a TX count of a RACH preamble. A value of the PRACH TX counter starts with 1 and is incremented by ‘1’ each time PRACH is transmitted. A UE may receive a maximum value of the PRACH TX counter from a higher layer. If a value of the PRACH TX counter is smaller than the maximum value, PRACH may be transmitted. If a value of the PRACH TX counter reaches the maximum value, PRACH is not transmitted and it may be determined that a problem exists in a random access procedure.

2) Associated operation 2

A. If a previous PRACH (initial) transmission CC is selected as a retransmission CC in the above option, PRACH power is raised (ramping-up). On the other hand, if a CC other than the previous PRACH (initial) transmission CC is selected as a retransmission CC, PRACH power is not raised (no ramping) (or, PRACH power ramping may be independently operated per CC).

3) Associated operation 3

A. If a previous PRACH (initial) transmission CC is selected as a retransmission CC, a Contention Window Size (CWS) may be increased. If a CC other than the previous PRACH (initial) transmission CC is selected as a retransmission CC, one of: (i) increasing CWS; (ii) maintaining CWS instead of increasing it; and (iii) initializing CWS may be operated (or, CSW may be independently operated per CC).

The CWS may consider: (a) a CWS (corresponding to the maximum number of selectable CCA slots) for (randomly) selecting the number of CCA slots to perform an LBT operation; and/or (b) a CWS (corresponding to the total number of candidate PRA resources becoming selection targets) targeted to select a retransmission PRACH resource (randomly).

A PRACH retransmission CC may be selected as a CC other than a previous PRACH (initial) transmission CC depending on the above operation.

In addition, in a U-band operation environment, it is able to consider: 1) PRACH resource/occasion semi-statically configured in advance via SIB (and/or RRC) (i.e., a semi-static RO set); and, additionally, 2) PRACH resource/occasion dynamically scheduled/assigned via DCI (and/or PDSCH) (i.e., a dynamic RO set). In case of the semi-static RO set and the dynamic RO set, they may be configured in a manner of being classified with respect to time and/or frequency. Meanwhile, if the dynamic RO set is configured/designated across multiple CCs (or BWPs or LBT-SBs), a UE may select a specific CC (having succeeded in LBT) from the corresponding multiple CCs (or BWPs or LBT-SBs) and then perform a PRACH (initial) transmission via the corresponding CC.

Meanwhile, in case of failing in RAR or Msg4 reception with respect to the PRACH (initial) transmission via the multiple-CC (or -BWP or -LBT-SB) based dynamic RO set, a method for a UE to determine a CC to perform a retransmission (to select a PRACH resource) for the corresponding PRACH may be necessary. To this end, in particular, the corresponding PRACH retransmission CC (or BWP or LBT-SB) may be determined as: 1) a CC (or BWP or LBT-SB) for which the semi-static RO set is determined (whereby a UE may operate to perform a PRACH retransmission in a manner of selecting one of multiple ROs configured in a semi-static RO set configured on the corresponding CC); 2) a CC directly indicated via DCI/PRSCH that has scheduled the dynamic RO set; 3) a CC having a specific index (e.g., a lowest index) among the multiple CCs configuring the corresponding dynamic RO set; or 4) a CC via which an initial PRACH transmission has been performed.

Alternatively, regarding a PRACH transmission via the above-described dynamic RO set (configured in a time/frequency resource region different from that of the semi-static RO set), a UE operation may be provided for a UE not to perform a retransmission for the corresponding PRACH. Alternatively, regarding the PRACH transmission via the dynamic RO set, whether to allow a UE to perform a retransmission by itself may be directly indicated via DCI/PDSCH that schedules the corresponding dynamic RO set.

(5) Step 5: Msg3 Tx CC configuring method (LBT included)

As a method of configuring a CC for Msg3 transmission (or an LBT target for the Msg3 transmission) in case of succeeding in RAR detection/reception via the CC selected in Step 3, at least one of the following options may be considered.

1) Opt 5-1: SS/BCH CC

A. An SS/BCH CC may be configured as a Msg3 TX (and LBT target) CC.

2) Opt 5-2: PRACH CC

A. A PRACH CC may be configured as a Msg3 TX (and LBT target) CC.

3) Opt 5-3: RAR CC

A. An RAR CC may be configured as a Msg3 TX (and LBT target) CC.

4) Opt 5-4: pre-configured by SIB or RRC (paring between PRACH CC and Msg3 CC)

A. Information on PRACH CC and Msg3 CC (or candidate Msg3 CC group) corresponding to the PRACH CC may be pre-configured in advance via SIB or RRC signaling.

5) Opt 5-5: indicated by RAR (Msg3 CC or candidate CC group)

A. Msg3 CC (or candidate Msg3 CC group) information may be designated via RAR (or PDCCH corresponding to it).

6) Opt 5-6: try to transmit Msg3 over multiple CCs (including SS/BCH CC or PRACH CC or RAR CC)

A. If a UE performs LBT on a specific CC group configured with multiple CCs, Msg3 transmission may be performed via one or more random CCs in the CC group. The CC group may be configured to include at least one of SS/BCH CC, PRACH CC, and RAR CC.

Meanwhile, as operations accompanied at a Step-5 execution timing and before and after the corresponding timing, the following matters may be considered.

1) Associated operation 1

A. If a Msg3 Tx (and LBT target) CC is configured as a CC group, i.e., multiple CCs in the above option, a UE may operate to perform LBT on the multiple CCs. If succeeding in the LBT, the UE may operate to configure a Msg3 TX CC by applying Step 2 (e.g., Opt 2-1 or Opt 2-5 in Step 2).

2) Associated operation 2

A. PRACH CC index and/or RAR CC index may be transmitted by being included in Msg3 (PUSCH). Depending on the PRACH CC index and/or the RAR CC index, parameters (e.g., cyclic shift and/or OCC sequence for DMRS, and data/DMRS scrambling parameter (ID) for PUSCH) used for Msg3 PUSCH signal configuration may be determined differently.

A Msg3 CC may be selected as a CC other than an SS/BCH CC, a CC other than a PRACH CC, or a CC other than an RAR CC.

(6) Step 6: Msg3 retransmission CC configuring method (LBT target CC included)

In case of failing in Msg4 detection/reception after Msg3 transmission via the CC selected in Step 5, as a method of configuring Msg3 retransmission (LBT target for it) CC, at least one of the following options may be considered.

1) Opt 6-1: keep initial Msg3 CC (or CC group including the CC)

A. A CC (or CC group) on which a previous Msg3 (initial) transmission was performed may be selected as a retransmission (and LBT target) CC.

2) Opt 6-2: change to different CC (group) from initial Msg3 CC (group)

A. A CC (or CC group) other than a CC (or CC group) on which a previous Msg3 (initial) transmission was performed may be selected as a Msg3 retransmission (and LBT target) CC.

3) Opt 6-3: Just go to Step 5 in Above

A. A Msg3 retransmission (and LBT target) CC may be selected by applying Step 5.

4) Opt 6-4: try LBT for initial Msg3 CC (group) then apply Opt 6-2 or Opt 6-3 if LBT is failed

A. LBT is attempted on a CC (or CC group) on which a previous Msg3 (initial) transmission was performed. If the attempt is successful, Opt 6-1 may be applied. If the attempt is not successful, Opt 6-3 may be applied.

Meanwhile, as operations accompanied at a Step-6 execution timing and before and after the corresponding timing, the following matters may be considered.

1) Associated operation 1

A. According to the LBT based U-band operation characteristics, it may be efficient that a retransmission for Msg3 is performed in a grant-less manner. Particularly, if Msg4 is not detected for a predetermined interval (e.g., X slots) after Msg3 transmission, retransmission for Msg3 may be performed (without transmission/detection for a separate UE grant).

B. (Grant-less) Msg3 retransmission with periodicity of X slots may be allowed maximum N times. If Msg4 is not detected for the N Msg3 retransmissions, a UE may perform PRACH retransmission.

C. Slot information or pattern (e.g., at least one of X value, N value, per-slot Msg3 TX frequency (e.g., CC/RB resource)) for allowing (grant-less) Msg3 retransmission may be indicated via RAR (and/or SIB).

D. Initially transmitted Msg3 (PUSCH) resource information (e.g., CC index, slot index) may be transmitted in a manner of being included in a retransmitted Msg3 (PUSCH), or via a parameter (e.g., cyclic shift and/or OCC sequence for DMRS, data/DMRS scrambling parameter (ID) for PUSCH) used to configure a retransmitted Msg3 (PUSCH) signal.

Msg3 retransmission CC may be selected as a CC other than a previous Msg3 (initial) transmission CC.

(7) Step 7: Msg4 Reception (RX) CC configuring method

As a method of configuring a Msg4 RX CC after Msg3 transmission via the CC selected in Step 5/6, at least one of the following options may be considered.

1) Opt 7-1: SS/BCH CC

A. Msg4 detection/reception may be performed via SS/BCH CC.

2) Opt 7-2: PRACH CC

A. Msg4 detection/reception may be performed via PRACH CC.

3) Opt 7-3: RAR CC

A. Msg4 detection/reception may be performed via RAR CC.

4) Opt 7-4: Msg3 CC

A. Msg4 detection/reception may be performed via Msg3.

5) Opt 7-5: pre-configured by SIB or RRC (paring between PRACH CC and Msg4 CC)

A. Information on PRACH CC and Msg4 CC (or candidate Msg4 CC group) corresponding to the PRACH CC may be pre-configured in advance via SIB or RRC signaling.

6) Opt 7-6: indicated by RAR (Msg4 CC or candidate CC group)

A. Information on a CC (or a CC group) on which Msg4 will be transmitted may be designated via RAR (or PDCCH corresponding to it).

7) Opt 7-7: try to detect Msg4 over multiple CCs (including SS/BCH or PRACH or RAR or Msg3 CC)

A. Msg4 detection/reception may be performed via a specific CC group configured with multiple CCs (or one random CC in the CC group). The CC group may be configured to include at least one of SS/BCH CC, PRACH CC, and RAR CC.

Meanwhile, as operations accompanied at a Step-7 execution timing and before and after the corresponding timing, the following matters may be considered.

1) Associated operation 1

A. If Msg4 RX CC is configured as CC group, i.e., multiple CCs in the above option, a UE may operate to attempt detection/reception of MSG4 (and PDCCH scheduling it) on the multiple CCs.

2) Associated operation 2

A. PRACH CC index and/or Msg3 CC index may be transmitted in a manner of being included in Msg4 (PDSCH) or indicated via PDCCH corresponding to Msg4.

Msg4 CC may be selected as CC other than SS/BCH CC, CC other than PRACH CC, CC other than RAR CC, or CC other than Msg3 CC.

In addition, CC combinations accompanied by a RACH process may be considered as follows.

1) Combination 1

A. PRACH CC, RAR CC, Msg3 CC and Msg4 CC may be configured identically, but previous PRACH (initial) transmission CC and PRACH retransmission CC may be configured different from each other.

2) Combination 2

A. RAR CC, Msg3 CC and Msg4 CC may be configured identically, but PRACH CC and RAR CC may be configured different from each other.

3) Combination 3

A. PRACH CC and RAR CC are configured identically, Msg3 CC and Msg4 CC are configured identically, but the PRACH CC and the Msg3 CC may be configured different from each other.

4) Combination 4

A. PRACH CC and Msg3 CC are configured identically, RAR CC and Msg4 CC are configured identically, but PRACH CC and RAR CC may be configured different from each other.

5) Combination 5

A. Previous PRACH (initial) transmission CC and PRACH retransmission CC may be determined different from each other, but previous Msg3 (initial) transmission CC and Msg3 retransmission CC may be provided as identical 1 to each other. Yet, BWP on which actual Msg3 transmission/retransmission is performed within Msg3 CC may be configured different between a previous (initial) transmission and a retransmission.

Meanwhile, the above proposed methods may be identically/similarly applicable if N=1, i.e., the PRACH preamble/resource configured CC/BWP number is 1 (based on this, if M=1, i.e., the number of CCs/BWPs succeeding in LBT is 1 that is equal to that of the PRACH-configured CC/BWP).

(8) Msg3 transmission based on multiple candidate resources

In a U-band operating situation, considering LBT failure (signal transmission drop due to this) in an RACH process, multiple candidate resources are allocated/configured on time and/or frequency, and a UE may consider a method of performing Msg3 (PUSCH) transmission via a specific resource succeeding in LBT among the multiple candidate resources. For example, multiple candidate resources (e.g., slots, symbol groups) TDMed on time for single Msg3 transmission may be configured. Based on this, a UE may operate to attempt LBT on the corresponding resources in order of time and transmit Msg3 via a resource initially succeeding in CCA. For another example, multiple candidate resources (e.g., LBT-SBs, BWPs, CCs) separated on frequency for single Msg3 transmission may be configured. Based on this, a UE may operate to attempt LBT on the corresponding multiple (frequency) resources and transmit Msg3 via a specific (frequency) resource succeeding in CCA.

Moreover, in L-band operating situation, multiple candidate resources are allocated/configured on time and/or frequency (via RAR and/or SIB), and a UE may consider a method of performing Msg3 (PUSCH) transmission via a resource randomly selected from the corresponding multiple resources or a specific resource selected according to a UL data size, (global) ID of the UE, and the like.

Meanwhile, if a UE operates to transmit Msg3 based on allocation/selection of multiple candidate resources, a gNB receiving stage may possibly succeed in simultaneously detecting multiple Msg3 signals (from different UEs) via multiple different candidate resources (allocated to Msg3 transmission) corresponding to one RAR. As described above, in a situation that a gNB detects Msg3 signals of multiple UEs for one RAR, if an existing method applies as it is, it may result in a structure that a specific UE among the corresponding multiple UEs succeeds in RRC connection via Msg4 (PDSCH) reception. Yet, in case of other UEs unselected, they should start with PRACH transmission again despite that the gNB has correctly detected the Msg3 signals and an LBT operation (CCA success via this operation) is required for all signal transmitting processes in a U-band situation, which may become considerably unnecessary and insufficient operations.

Therefore, in case of occurrence of a situation that multiple Msg3 signals are detected for one RAR, as described above, multiple UEs corresponding to the multiple Msg3 signals are allowed to access as many as possible, which may be efficient in both aspects of resource and latency. To enable the accesses by multiple Msg3 Tx UEs, the following method may be considered.

1) Whether to confirm to use RC-RNTI as C-RNTI intactly or assign a value different from TC-RNTI as C-RNTI finally may be indicated to a UE via Msg4 (PDSCH).

A. Moreover, additional TA command may be indicated via Msg4 (in addition to TA indicated with RAR previously), and a UE may operate to perform HARQ-ACK PUCCH transmission in response to Msg4 reception by applying TA updated on the basis of the RA command.

2) A UE may operate to monitor Msg4 until a CR timer expires, despite that UE ID included in Msg4 having succeeded in decoding (at the timing before the expiration of the CR timer) differs from ID of the UE.

A. Alternatively, the number of the remaining Msg4 (to be further scheduled/transmitted with the same TC-RNTI) or information (e.g., index) of an Msg3 detected candidate resource may be indicated to a UE via Msg4. (For convenience, this is referred to as Opt 8-1 (Alt 1).)

B. Alternatively, to reduce decoding load of a UE for Msg4 (PDSCH), the above information (e.g., a Msg3 detected candidate resource index) may be indicated via a DCI field in TC-RNTI based PDCCH for scheduling Msg4. (For convenience, this is referred to as Opt 8-1 (Alt 2).)

3) Alternatively, an individual (different) TC-RNTI may be assigned to each of multiple candidate resources for transmission of Msg3 corresponding to one RAR (or RACH preamble index: RAPID). (For convenience, this is referred to as Opt 8-2.)

A. Accordingly, a UE may operate to perform monitoring on TC-RNTI (PDCCH) corresponding to a candidate resource (e.g., resource A) selected/transmitted by the UE.

B. In the above case, the following scheduling information may be included in PDCCH indicated by the corresponding TC-RNTI. i) DL grant DCI for scheduling Msg4 (PDSCH) corresponding to a resource A (Msg3 transmission via this resource) and/or ii) UL grant DCI for scheduling retransmission for Msg3 (PUSCH) corresponding to a resource A (Msg3 transmission via this resource)

4) If a UE repeatedly transmits Msg3 on multiple candidate resources, the corresponding UE may operate to continuously perform monitoring on Msg4 or PDCCH corresponding to the corresponding multiple resource number/index.

In addition, in the above operation situation, a structure of scheduling/indicating retransmission of Msg3 (PUSCH) by separating it for each candidate resource may be efficient. Hence, via a retransmission UL grant DCI for Msg3 (e.g., in case of applying Opt 8-1), it may consider a method of indicating that the corresponding DCI indicates a retransmission scheduling for Msg3 transmission on which candidate resource of a previous timing.

Alternatively, in a state that a single TC-RNTI is assigned per RAR (or RAPID) (like the existing method) (on the same assumption of Opt 8-1), (one or) multiple Msg4 information (in form of MAC CE format) may be included and transmitted via one PDSCH scheduled from PDCCH based on the corresponding TC-RNTI. It is able to consider a method of indicating that each of the multiple Msg4 is the information corresponding to which candidate resource (Msg3 transmission via this resource) (e.g., in form of Mac (sub-)header of each MSg4).

Alternatively, via one PDSCH #1 scheduled from TC-RNTI based PDCCH (on the same assumption above), multiple DL grant DCIs (scheduling multiple Msg4 (PDSCH #2) transmissions, respectively) may be included and transmitted. (In this case, a method of indicating Msg4 corresponding to which candidate resource (Msg3 transmission via this resource) via the corresponding DCI is available.) A UE may operate to receive Msg4 information finally via PDSCH #2 scheduled from DL grant DCI (corresponding to a candidate resource selected for Msg3 transmission by the UE) within the corresponding PDSCH #1.

Meanwhile, C-RNTI information finally assigned to a UE may be included in the Msg4 transmission at least. Additionally, PUSCH resource information to use for HARQ-ACK feedback transmission for the corresponding Msg4 (PDSCH) reception (and/or TA information to apply to UL transmission) may be further included.

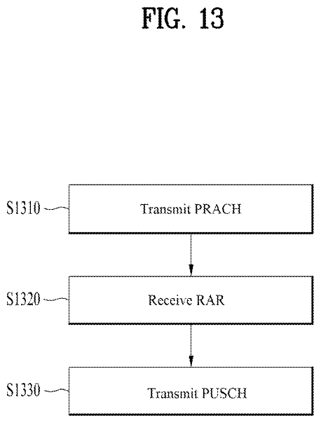

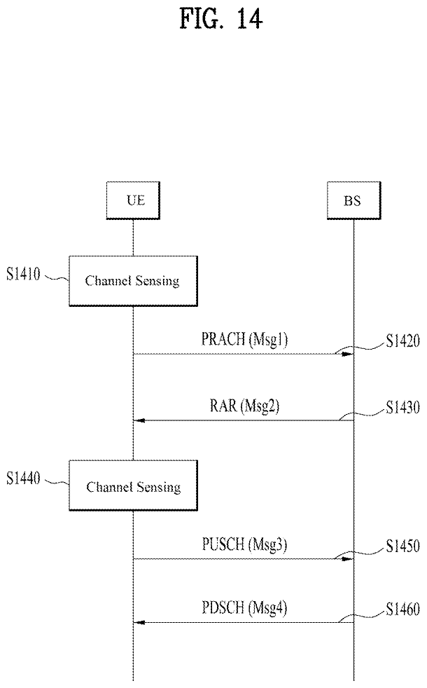

FIG. 13 and FIG. 14 show examples of performing an RACH process according to an embodiment of the present disclosure.

Referring to FIG. 13, a US may transmit PRACH (Msg1) to a BS based on a channel sensing result [S1310]. The UE may receive RAR (Msg2) from the BS in response to the PRACH [S1320]. The UE may transmit PUSCH (Msg3) based on a UL grant in the PRAR [S1330]. The UE may perform channel sensing on a plurality of candidate resources for the PUSCH transmission. A plurality of the candidate resources may include a plurality of candidate symbol groups or a plurality of candidate frequency regions. For example, the symbol group may mean a symbol group including one or more symbols. For example, the UE may perform channel sensing in symbol index order such as symbol indexes #0, #1 . . . in a candidate symbol group and then transmit PSUCH in a symbol having succeeding in the channel sensing initially. Thereafter, the UE may receive PDSCH (Msg4) from the BS. The Msg4 may include UE (global) ID and/or RRC connection related information for contention resolution.

In detail, referring to FIG. 14, a UE may perform channel sensing [S1410] and then transmit PRACH on a resource having succeeded in the channel sensing [S1420]. ABS may transmit RAR to the UE in response to the PRACH [S1430]. The UE may perform channel sensing [S1440] and then transmit PUSCH on a resource having succeeded in the channel sensing [S1450]. For example, a plurality of candidate resources becoming a target of the channel sensing for PUSCH transmission for Msg3 may include a plurality of candidate symbols or a plurality of candidate carriers. Allocation information of a plurality of the candidate resources may be included in SIB or RAR. In response to the PUSCH, the UE may receive PDSCH including RRC connection information from the BS [S1460]. For example, the PDSCH may be received on one of a carrier pre-configured via a higher layer signal, a carrier indicated via PDCCH including scheduling information (e.g., DL grant DCI) of the PDSCH, and a carrier indicated via the RAR. For example, a receiving stage of the BS may detect a plurality of Msg3 (PUSCH) for a plurality of UEs via a plurality of the candidate resources allocated to Msg3 (PUSCH) transmission. Namely, a plurality of Msg3 (PUSCH) may be detected for one RAR. To enable UEs to access as many as possible in consideration of latency due to channel sensing in U-band situation, various methods may be taken into consideration. For example, the UE may receive information (e.g., symbol index) of a resource from which the Msg3 was detected by the receiving stage of the BS. The information of the Msg3 detected resource may be included in Msg4 (PDSCH) or indicated via DCI in PDCCH scheduling the Msg4 (PDSCH). For another example, the UE may receive assignment of TC-RNTIs different for a plurality of the candidate resources for the Msg3 (PUSCH) transmission, respectively. The UE may perform monitoring on PDCCH indicated by the TC-RNTI corresponding to the resource having carried the Msg3 (PUSCH) only.

(9) Scheduling request transmission related operation on U-band

Regarding SR transmission in a legacy L-band system, SR transmission period and SR PUCCH resource are pre-configured in advance via RRC signaling.

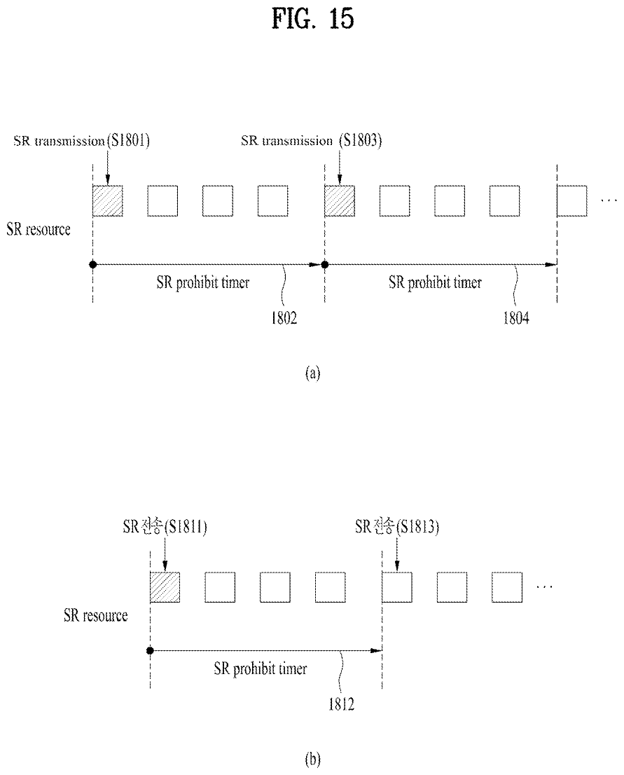

FIG. 15 (a) is a diagram showing an example of SR transmission in L-band system, and FIG. 15 (b) shows an example of applying an embodiment of the present disclosure in U-band system.

A UE may operate to transmit SR PUCCH configured for a SR transmission timing nearest to a timing of triggering a positive SR. Moreover, each time the UE performs SR transmission, an SR transmission counter value is incremented. And, an SR prohibit timer value is reset at an SR transmission timing, whereby the SR prohibit timer starts to be driven. SR transmission may be dropped until the SR prohibit timer expires (e.g., until a maximum value is reached).

Referring to FIG. 15 (a), a UE may transmit SR at a timing configured using a resource (e.g., PUCCH) configured for SR transmission [1801]. If there is no resource configured for SR transmission, the UE may initiate a random access procedure. Once SR is transmitted [1801], an SR counter value is incremented by ‘1’ and an SR prohibit timer value is reset, whereby the SR prohibit timer starts to be driven [1802]. While the SR prohibit timer is driven, SR transmission is not performed. If the SR prohibit timer expires, i.e., if a value of the SR prohibit timer reaches a preset value (e.g., maximum value), transmission of a next SR is performed [1803], a value of the SR counter is incremented by ‘1’, and the value of the SR prohibit timer is reset, whereby the SR prohibit timer starts to be driven again [1804]. If the value of the SR counter reaches a preset specific value (e.g., dsr-TransMax), the UE may initiate a random access procedure without further performing SR transmission. The dsr-TransMax value and the SR prohibit timer value preventing the SR transmission may be the information included in RRC signaling or may be set based on information included in RRC signaling.

Objects of the SR counter and the SR prohibit timer may be to prevent: 1) too frequent SR transmissions; and 2) an operation that the UE easily enters a random access process as the SR counter quickly reaches dsr-TransMax.

Meanwhile, in U-band, the configuration and UE operations similar to the above description may be taken into consideration. In U-band environment, a UE may perform SR transmission in consideration of LBT. If the UE fails in LBT for an SR transmission timing configured in a state that a positive SR is triggered, it may be necessary to consider how to operate an SR counter and an SR prohibit timer preferably.

Referring to FIG. 15 (b), as a UE performs LBT, if there is a resource capable of carrying SR, the UE transmits the SR [1811]. A value of an SR counter is incremented by ‘1’ and an SR prohibit timer starts to be driven [1812]. While the SR prohibit timer is driven, SR transmission is not performed. If a value of the SR prohibit timer reaches a preset value, i.e., if a value of the SR counter is smaller than a value of drs-TransMax in the legacy L-band at an expiration timing of driving the SR prohibit timer [1813], the SR transmission can always restart. However, in U-band, if the UE is unable to occupy a resource for carrying SR according to the LBT result, it is unable to transmit the SR. If the UE is unable to transmit the SR because of failing in the LBT at the timing 1813, it causes a problem of how to handle a value of the SR counter and a value of the SR prohibit timer. The present disclosure proposes three kinds of options as follows.

1) Opt 9-1: no increase of SR counter+no reset of SR prohibit timer

A. No increase pf SR counter value and no reset of SR prohibit timer

According to this option, even in case of failing in LBT, at the timing 1813, a value of an SR prohibit timer is not reset but can be continuously maintained in a state of reaching a preset value (maximum value). Hence, a UE attempts SR transmission (LBT operation for the same) again via an SR-configured timing nearest to the LBT failure timing, thereby minimizing SR transmission latency. Besides, if the SR counter value reaches drs-TransMax too quickly, it is unnecessary for a random access process to be performed early. Thus, it is able to prevent the random access process from being performed early.

2) Opt 9-2: increase of SR counter+no reset of SR prohibit timer

A. Increase of SR counter and no reset of SR prohibit timer

B. According to this option, SR transmission latency can be minimized via the SR prohibit timer processing in Opt 9-1, and the SR counter may be led to switch to an RACH process without unnecessary latency in a situation of high interference by increasing the SR counter even in case of LBT failure.

3) Opt 9-3: increase of SR counter+reset of SR prohibit timer

A. In this case, an SR counter value is increased and an SR prohibit timer is reset.

B. According to this option, even in case of LBT failure (dropping SR transmission due to this failure), an SR counter and an SR prohibit timer are processed equivalent to a case of normally performing SR transmission. Therefore, an SR transmission occasion/frequency number and an RACH process switch time can be operated in a manner almost identical to that of an existing L-band environment.

In addition, if a UE fails in LBT with respect to a (configured) SR transmission timing, a method of decreasing an SR prohibit timer expiring value (maximum value) is available as well. Meanwhile, ‘reset’ in the above description may mean an operation of initializing a value of an SR prohibit timer and then restarting the SR prohibit timer with an initial value. On the other hand, ‘not reset’ may mean an operation of not restarting the SR prohibit timer without initializing the value of the SR prohibit timer (e.g., maintain a state that the SR prohibit timer stops at the maximum value).

Meanwhile, since Opt 9-1 in the above description is a situation that SR (PUCCH) transmission is dropped due to UE's LBT failure, an operation of not increasing an SR counter value may be considered. However, if the SR counter is continuously maintained without increase despite that a UE keeps failing in LBT across multiple SR timings, an operation of switching to an RACH process at an appropriate timing may become impossible. Therefore, by considering this, in case of (consecutively) failing in LBT across a specific number (e.g., M, M>1) or a plurality of (contiguous) SR transmission timings corresponding to a specific time duration, the following UE operation may be provided.
Increase an SR counter (e.g., add 1 to the SR counter if failing in LBT with respect to M contiguous SR transmission timings all).
Switch to an RACH process directly (irrespective of an SR counter value).
A UE forwards an LBT failure result to its higher layer.
Declare Radio Link Failure (RLF).

Meanwhile, in U-band environment, considering a situation that SR (PUSCH) transmission is dropped due to UE's LBT failure, it may consider a method of configuring multiple (TDMed) candidate SR TX (PUCCH) resources per single SR TX timing while periodically configuring an SR transmission timing based on a specific period. A UE may sequentially perform LBT on multiple candidate SR (PUCCH) resources configured at a single SR TX timing and operate to transmit SR information via a resource succeeding in LBT at first (or all resources configured at a later timing as well as the corresponding resource). Similarly to the above, if (consecutively) failing in LBT across a specific number (e.g., M, M>1) or a plurality of (contiguous) SR transmission timings corresponding to a specific time duration or a specific number (e.g., L, L>1) of (contiguous) candidate SR resources, a UE operation may be provided in a manner of increasing an SR counter or directly switching to an RACH process (that a UE forwards a corresponding result to its higher layer or declares RLF).

(10) SRS switching related operation in U-band

In case of an SRS switching operation in a legacy L-band system, a UE may operate to resume UL transmission in a manner of stopping UL transmission on a source CC, performing SRS transmission on a target CC via frequency tuning, and then changing into the source CC again via frequency retuning. Namely, a UE having limited UL CA capability configures DL only CC as target CC and then performs an SRS switching operation, which may be intended to perform fast DL CSI acquisition using channel reciprocity in TDD situation.

Meanwhile, in U-band, the configuration and UE operation similar to the above description may be considered. In this case, interruption time and resource efficiency on source CC may vary depending on LBT success/failure on target CC. Therefore, the following operation/configuration method is proposed.

1) SRS switching UE operation

A. In case of succeeding in LBT on target CC, it may operate to perform SRS transmission the CC and switch to a source CC. In case of failing in LBT on target CC, it may operate to directly switch to source CC without SRS transmission (by dropping SRS transmission on the CC).

2) SRS switching configuration

A. Multiple LBT timings for SRS transmission may be configured for target CC (i.e., LBT is allowed multiple times) and/or multiple candidate SRS symbols may be configured, A UE may operate to perform SRS transmission corresponding to a timing of first succeeding in LBT and then switch to source CC directly (by dropping an additional LBT operation).

The various descriptions, functions, procedures, proposals, methods, and/or operation flowcharts of the present disclosure described herein may be applied to, but not limited to, various fields requiring wireless communication/connectivity (e.g., 5G) between devices.

More specific examples will be described below with reference to the drawings. In the following drawings/description, like reference numerals denote the same or corresponding hardware blocks, software blocks, or function blocks, unless otherwise specified.

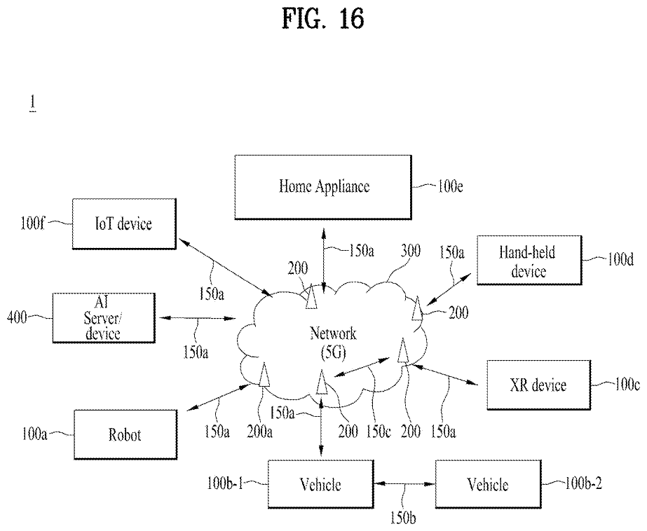

FIG. 16 illustrates a communication system 1 applied to the present disclosure.

Referring to FIG. 16, the communication system 1 applied to the present disclosure includes wireless devices, BSs, and a network. A wireless device is a device performing communication using radio access technology (RAT) (e.g., 5G NR (or New RAT) or LTE), also referred to as a communication/radio/5G device. The wireless devices may include, not limited to, a robot 100a, vehicles 100b-1 and 100b-2, an extended reality (XR) device 100c, a hand-held device 100d, a home appliance 100e, an IoT device 100f, and an artificial intelligence (AI) device/server 400. For example, the vehicles may include a vehicle having a wireless communication function, an autonomous driving vehicle, and a vehicle capable of vehicle-to-vehicle (V2V) communication. Herein, the vehicles may include an unmanned aerial vehicle (UAV) (e.g., a drone). The XR device may include an augmented reality (AR)/virtual reality (VR)/mixed reality (MR) device and may be implemented in the form of a head-mounted device (HMD), a head-up display (HUD) mounted in a vehicle, a television (TV), a smartphone, a computer, a wearable device, a home appliance, a digital signage, a vehicle, a robot, and so on. The hand-held device may include a smartphone, a smartpad, a wearable device (e.g., a smartwatch or smartglasses), and a computer (e.g., a laptop). The home appliance may include a TV, a refrigerator, a washing machine, and so on. The IoT device may include a sensor, a smartmeter, and so on. For example, the BSs and the network may be implemented as wireless devices, and a specific wireless device 200a may operate as a BS/network node for other wireless devices.

The wireless devices 100a to 100f may be connected to the network 300 via the BSs 200. An AI technology may be applied to the wireless devices 100a to 100f, and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without intervention of the BSs/network. For example, the vehicles 100b-1 and 100b-2 may perform direct communication (e.g. V2V/vehicle-to-everything (V2X) communication). The IoT device (e.g., a sensor) may perform direct communication with other IoT devices (e.g., sensors) or other wireless devices 100a to 100f.

Wireless communication/connections 150a, 150b, and 150c may be established between the wireless devices 100a to 100f/BS 200 and between the BSs 200. Herein, the wireless communication/connections may be established through various RATs (e.g., 5G NR) such as UL/DL communication 150a, sidelink communication 150b (or, D2D communication), or inter-BS communication (e.g. relay or integrated access backhaul (IAB)). Wireless signals may be transmitted and received between the wireless devices, between the wireless devices and the BSs, and between the BSs through the wireless communication/connections 150a, 150b, and 150c. For example, signals may be transmitted and receive don various physical channels through the wireless communication/connections 150a, 150b and 150c. To this end, at least a part of various configuration information configuring processes, various signal processing processes (e.g., channel encoding/decoding, modulation/demodulation, and resource mapping/demapping), and resource allocation processes, for transmitting/receiving wireless signals, may be performed based on the various proposals of the present disclosure.

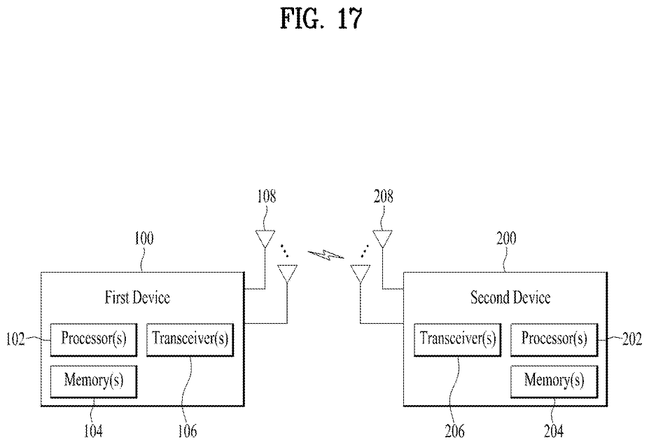

FIG. 17 illustrates wireless devices applicable to the present disclosure.

Referring to FIG. 17, a first wireless device 100 and a second wireless device 200 may transmit wireless signals through a variety of RATs (e.g., LTE and NR). {The first wireless device 100 and the second wireless device 200} may correspond to {the wireless device 100x and the BS 200} and/or {the wireless device 100x and the wireless device 100x} of FIG. 16.

The first wireless device 100 may include one or more processors 102 and one or more memories 104, and further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operation flowcharts disclosed in this document. For example, the processor(s) 102 may process information in the memory(s) 104 to generate first information/signals and then transmit wireless signals including the first information/signals through the transceiver(s) 106. The processor(s) 102 may receive wireless signals including second information/signals through the transceiver(s) 106 and then store information obtained by processing the second information/signals in the memory(s) 104. The memory(s) 104 may be connected to the processor(s) 102 and may store various pieces of information related to operations of the processor(s) 102. For example, the memory(s) 104 may store software code including instructions for performing all or a part of processes controlled by the processor(s) 102 or for performing the descriptions, functions, procedures, proposals, methods, and/or operation flowcharts disclosed in this document. The processor(s) 102 and the memory(s) 104 may be a part of a communication modem/circuit/chip designed to implement RAT (e.g., LTE or NR). The transceiver(s) 106 may be connected to the processor(s) 102 and transmit and/or receive wireless signals through the one or more antennas 108. Each of the transceiver(s) 106 may include a transmitter and/or a receiver. The transceiver(s) 106 may be interchangeably used with radio frequency (RF) unit(s). In the present disclosure, the wireless device may be a communication modem/circuit/chip.

The second wireless device 200 may include one or more processors 202 and one or more memories 204, and further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operation flowcharts disclosed in this document. For example, the processor(s) 202 may process information in the memory(s) 204 to generate third information/signals and then transmit wireless signals including the third information/signals through the transceiver(s) 206. The processor(s) 202 may receive wireless signals including fourth information/signals through the transceiver(s) 106 and then store information obtained by processing the fourth information/signals in the memory(s) 204. The memory(s) 204 may be connected to the processor(s) 202 and store various pieces of information related to operations of the processor(s) 202. For example, the memory(s) 204 may store software code including instructions for performing all or a part of processes controlled by the processor(s) 202 or for performing the descriptions, functions, procedures, proposals, methods, and/or operation flowcharts disclosed in this document. The processor(s) 202 and the memory(s) 204 may be a part of a communication modem/circuit/chip designed to implement RAT (e.g., LTE or NR). The transceiver(s) 206 may be connected to the processor(s) 202 and transmit and/or receive wireless signals through the one or more antennas 208. Each of the transceiver(s) 206 may include a transmitter and/or a receiver. The transceiver(s) 206 may be interchangeably used with RF unit(s). In the present disclosure, the wireless device may be a communication modem/circuit/chip.

Now, hardware elements of the wireless devices 100 and 200 will be described in greater detail. One or more protocol layers may be implemented by, not limited to, one or more processors 102 and 202. For example, the one or more processors 102 and 202 may implement one or more layers (e.g., functional layers such as physical (PHY), medium access control (MAC), radio link control (RLC), packet data convergence protocol (PDCP), RRC, and service data adaptation protocol (SDAP)). The one or more processors 102 and 202 may generate one or more protocol data units (PDUs) and/or one or more service data Units (SDUs) according to the descriptions, functions, procedures, proposals, methods, and/or operation flowcharts disclosed in this document. The one or more processors 102 and 202 may generate messages, control information, data, or information according to the descriptions, functions, procedures, proposals, methods, and/or operation flowcharts disclosed in this document and provide the messages, control information, data, or information to one or more transceivers 106 and 206. The one or more processors 102 and 202 may generate signals (e.g., baseband signals) including PDUs, SDUs, messages, control information, data, or information according to the descriptions, functions, procedures, proposals, methods, and/or operation flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operation flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. For example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. The descriptions, functions, procedures, proposals, methods, and/or operation flowcharts disclosed in this document may be implemented using firmware or software, and the firmware or software may be configured to include the modules, procedures, or functions. Firmware or software configured to perform the descriptions, functions, procedures, proposals, methods, and/or operation flowcharts disclosed in this document may be included in the one or more processors 102 and 202 or may be stored in the one or more memories 104 and 204 and executed by the one or more processors 102 and 202. The descriptions, functions, procedures, proposals, methods, and/or operation flowcharts disclosed in this document may be implemented using firmware or software in the form of code, an instruction, and/or a set of instructions.

The one or more memories 104 and 204 may be connected to the one or more processors 102 and 202 and store various types of data, signals, messages, information, programs, code, instructions, and/or commands. The one or more memories 104 and 204 may be configured to include read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or wireless signals/channels, mentioned in the methods and/or operation flowcharts of this document, to one or more other devices. The one or more transceivers 106 and 206 may receive user data, control information, and/or wireless signals/channels, mentioned in the descriptions, functions, procedures, proposals, methods, and/or operation flowcharts disclosed in this document, from one or more other devices. For example, the one or more transceivers 106 and 206 may be connected to the one or more processors 102 and 202 and transmit and receive wireless signals. For example, the one or more processors 102 and 202 may perform control so that the one or more transceivers 106 and 206 may transmit user data, control information, or wireless signals to one or more other devices. The one or more processors 102 and 202 may perform control so that the one or more transceivers 106 and 206 may receive user data, control information, or wireless signals from one or more other devices. The one or more transceivers 106 and 206 may be connected to the one or more antennas 108 and 208 and the one or more transceivers 106 and 206 may be configured to transmit and receive user data, control information, and/or wireless signals/channels, mentioned in the descriptions, functions, procedures, proposals, methods, and/or operation flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received wireless signals/channels from RF band signals into baseband signals in order to process received user data, control information, and wireless signals/channels using the one or more processors 102 and 202. The one or more transceivers 106 and 206 may convert the user data, control information, and wireless signals/channels processed using the one or more processors 102 and 202 from the baseband signals into the RF band signals. To this end, the one or more transceivers 106 and 206 may include (analog) oscillators and/or filters.

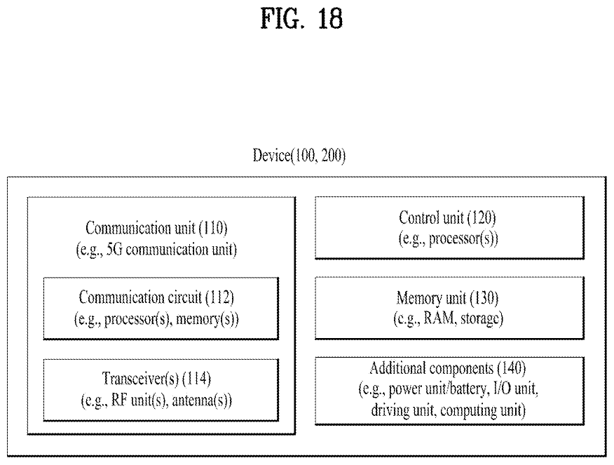

FIG. 18 illustrates another example of a wireless device applied to the present disclosure. The wireless device may be implemented in various forms according to a use case/service (refer to FIG. 16).

Referring to FIG. 18, wireless devices 100 and 200 may correspond to the wireless devices 100 and 200 of FIG. 16 and may be configured to include various elements, components, units/portions, and/or modules. For example, each of the wireless devices 100 and 200 may include a communication unit 110, a control unit 120, a memory unit 130, and additional components 140. The communication unit 110 may include a communication circuit 112 and transceiver(s) 114. For example, the communication circuit 112 may include the one or more processors 102 and 202 and/or the one or more memories 104 and 204 of FIG. 16. For example, the transceiver(s) 114 may include the one or more transceivers 106 and 206 and/or the one or more antennas 108 and 208 of FIG. 16. The control unit 120 is electrically connected to the communication unit 110, the memory 130, and the additional components 140 and provides overall control to the wireless device. For example, the control unit 120 may control an electric/mechanical operation of the wireless device based on programs/code/instructions/information stored in the memory unit 130. The control unit 120 may transmit the information stored in the memory unit 130 to the outside (e.g., other communication devices) via the communication unit 110 through a wireless/wired interface or store, in the memory unit 130, information received through the wireless/wired interface from the outside (e.g., other communication devices) via the communication unit 110.

The additional components 140 may be configured in various manners according to type of the wireless device. For example, the additional components 140 may include at least one of a power unit/battery, input/output (I/O) unit, a driving unit, and a computing unit. The wireless device may be implemented in the form of, not limited to, the robot (100a of FIG. 16), the vehicles (100b-1 and 100b-2 of FIG. 16), the XR device (100c of FIG. 16), the hand-held device (100d of FIG. 16), the home appliance (100e of FIG. 16), the IoT device (100f of FIG. 16), a digital broadcasting terminal, a hologram device, a public safety device, an MTC device, a medical device, a FinTech device (or a finance device), a security device, a climate/environment device, the AI server/device (400 of FIG. 16), the BSs (200 of FIG. 16), a network node, or the like. The wireless device may be mobile or fixed according to a use case/service.

In FIG. 18, all of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module in the wireless devices 100 and 200 may further include one or more elements. For example, the control unit 120 may be configured with a set of one or more processors. For example, the control unit 120 may be configured with a set of a communication control processor, an application processor, an electronic control unit (ECU), a graphical processing unit, and a memory control processor. In another example, the memory 130 may be configured with a RAM, a dynamic RAM (DRAM), a ROM, a flash memory, a volatile memory, a non-volatile memory, and/or a combination thereof.

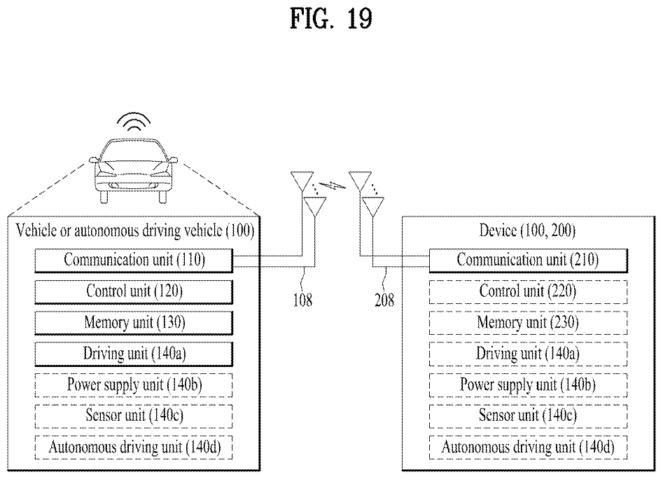

FIG. 19 illustrates a vehicle or an autonomous driving vehicle applied to the present disclosure. The vehicle or autonomous driving vehicle may be implemented as a mobile robot, a car, a train, a manned/unmanned aerial vehicle (AV), a ship, or the like.

Referring to FIG. 19, a vehicle or autonomous driving vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110. The blocks 110/130/140a to 140d correspond to the blocks 110/130/140 of FIG. 16, respectively.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous driving vehicle 100. The control unit 120 may include an ECU. The driving unit 140a may enable the vehicle or the autonomous driving vehicle 100 to drive on a road. The driving unit 140a may include an engine, a motor, a powertrain, a wheel, a brake, a steering device, and so on. The power supply unit 140b may supply power to the vehicle or the autonomous driving vehicle 100 and include a wired/wireless charging circuit, a battery, and so on. The sensor unit 140c may acquire information about a vehicle state, ambient environment information, user information, and so on. The sensor unit 140c may include an inertial measurement unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, and so on. The autonomous driving unit 140d may implement technology for maintaining a lane on which the vehicle is driving, technology for automatically adjusting speed, such as adaptive cruise control, technology for autonomously driving along a determined path, technology for driving by automatically setting a route if a destination is set, and the like.

For example, the communication unit 110 may receive map data, traffic information data, and so on from an external server. The autonomous driving unit 140d may generate an autonomous driving route and a driving plan from the obtained data. The control unit 120 may control the driving unit 140a such that the vehicle or autonomous driving vehicle 100 may move along the autonomous driving route according to the driving plan (e.g., speed/direction control). During autonomous driving, the communication unit 110 may aperiodically/periodically acquire recent traffic information data from the external server and acquire surrounding traffic information data from neighboring vehicles. During autonomous driving, the sensor unit 140c may obtain information about a vehicle state and/or surrounding environment information. The autonomous driving unit 140d may update the autonomous driving route and the driving plan based on the newly obtained data/information. The communication unit 110 may transfer information about a vehicle position, the autonomous driving route, and/or the driving plan to the external server. The external server may predict traffic information data using AI technology based on the information collected from vehicles or autonomous driving vehicles and provide the predicted traffic information data to the vehicles or the autonomous driving vehicles.

The embodiments of the present disclosure described above are combinations of elements and features of the present disclosure. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions of any one embodiment may be included in another embodiment and may be replaced with corresponding constructions of another embodiment. It is obvious to those skilled in the art that claims that are not explicitly cited in each other in the appended claims may be presented in combination as an embodiment of the present disclosure or included as a new claim by a subsequent amendment after the application is filed.

The embodiments of the present disclosure have been described above, focusing on the signal transmission and reception relationship between a UE and a BS. The signal transmission and reception relationship is extended to signal transmission and reception between a UE and a relay or between a BS and a relay in the same manner or a similar manner. A specific operation described as performed by a BS may be performed by an upper node of the BS. Namely, it is apparent that, in a network comprised of a plurality of network nodes including a BS, various operations performed for communication with a UE may be performed by the BS, or network nodes other than the BS. The term BS may be replaced with the term fixed station, Node B, enhanced Node B (eNode B or eNB), access point, and so on. Further, the term UE may be replaced with the term terminal, mobile station (MS), mobile subscriber station (MSS), and so on.

Those skilled in the art will appreciate that the present disclosure may be carried out in other specific ways than those set forth herein without departing from the spirit and essential characteristics of the present disclosure. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

The present disclosure is usable for a UE, a BS or other equipments of a wireless mobile communication system.

What is claimed is:

1. A method by a user equipment in a wireless communication system, the method comprising:
transmitting a Physical Random Access Channel (PRACH) based on a channel sensing result;
receiving a Random Access Response (RAR) in response to the PRACH; and
transmitting a Physical Uplink Shared Channel (PUSCH) based on the RAR,
wherein the PUSCH is transmitted on a first resource in which channel sensing is succeeded among a plurality of candidate resources and
wherein the plurality of candidate resources include a plurality of symbol groups or a plurality of frequency regions.

2. The method of claim 1, wherein allocation information of the plurality of candidate resources is included in System Information Block (SIB) or the RAR.

3. The method of claim 1, comprising receiving a Physical Downlink Shared Channel (PDSCH) including Radio Access Control (RRC) connection information in response to the PUSCH,
wherein the PDSCH is received on one of: i) a carrier pre-configured via a higher layer signal; ii) a carrier indicated via a Physical Downlink Control Channel (PDCCH) including scheduling information of the PDSCH; or iii) a carrier indicated via the RAR.

4. The method of claim 3, wherein the PDSCH includes a Timing Advance (TA) command and
wherein response information to the reception of the PDSCH is transmitted on a Physical Uplink Control Channel (PUCCH) in which TA is applied based on the TA command.

5. The method of claim 3, comprising receiving index information of a resource from which the PUSCH is detected,
wherein the index information is included in the PDSCH or the scheduling information.

6. The method of claim 3, wherein the plurality of candidate resources are identified with different Temporary Cell-Radio Network Temporary Identifiers (TC-RNTIs) and wherein the PDCCH is indicated by the TC-RNTI related to the first resource.

7. A user equipment in a wireless communication system, the user equipment comprising:
at least one processor;
at least one transceiver; and
at least one computer memory operationally connected to the at least one processor and the at least one transceiver and enabling the at least one processor and the at least one transceiver to perform an operation when executed,
wherein the operation comprises transmitting a Physical Random Access Channel (PRACH) based on a channel sensing result, receiving a Random Access Response (RAR) in response to the PRACH, and transmitting a Physical Uplink Shared Channel (PUSCH) based on the RAR,
wherein the PUSCH is transmitted on a first resource in which channel sensing is succeeded among a plurality of candidate resources, and
wherein the plurality of candidate resources include a plurality of symbol groups or multiple frequency regions.

8. The user equipment of claim 7, wherein allocation information of the plurality of candidate resources is included in System Information Block (SIB) or the RAR.

9. The user equipment of claim 7, wherein a Physical Downlink Shared Channel (PDSCH) including Radio Access Control (RRC) connection information is received in response to the PUSCH and
wherein the PDSCH is received on one of: i) a carrier pre-configured via a higher layer signal; ii) a carrier indicated via a Physical Downlink Control Channel (PDCCH) including scheduling information of the PDSCH; or iii) a carrier indicated via the RAR.

10. The user equipment of claim 9, wherein the PDSCH includes a Timing Advance (TA) command and wherein response information to the reception of the PDSCH is transmitted on a Physical Uplink Control Channel (PUCCH) in which TA is applied based on the TA command.

11. The user equipment of claim 9, wherein the operation comprises receiving index information of a resource from which the PUSCH is detected and
wherein the index information is included in the PDSCH or the scheduling information.

12. The user equipment of claim 9, wherein the plurality of candidate resources are identified with different Temporary Cell-Radio Network Temporary Identifiers (TC-RNTIs) and wherein the PDCCH is indicated by the TC-RNTI related to the first resource.

13. The user equipment of claim 7, wherein the UE communicates with at least one of a network or autonomous vehicles other than the user equipment.

14. An apparatus used in a wireless communication system, the apparatus comprising:
at least one processor; and
at least one memory storing one or more commands enabling the at least one processor to perform an operation,
wherein the operation comprises transmitting a Physical Random Access Channel (PRACH) based on a channel sensing result, receiving a Random Access Response (RAR) in response to the PRACH, and transmitting a Physical Uplink Shared Channel (PUSCH) based on the RAR,
wherein the PUSCH is transmitted on a first resource in which channel sensing is succeeded in channel sensing among a plurality of candidate resources, and
wherein the plurality of candidate resources include a plurality of symbol groups or multiple frequency regions.

15. A processor-readable medium storing one or more commands enabling at least one processor to perform an operation,
wherein the operation comprises transmitting a Physical Random Access Channel (PRACH) based on a channel sensing result, receiving a Random Access Response (RAR) in response to the PRACH, and transmitting a Physical Uplink Shared Channel (PUSCH) based on the RAR,
wherein the PUSCH is transmitted on a first resource in which channel sensing is succeeded among a plurality of candidate resources, and
wherein the plurality of candidate resources include a plurality of symbol groups or multiple frequency regions.
